(19) United States
(12) Patent Application Publication
(10) Pub. No.: US 2003/0187769 A1
(43) Pub. Date: Oct. 2, 2003

(54) Assets management method and assets management system

(76) Inventors: Hidenobu Muramatsu, Yokohama (JP); Motoaki Hirabayashi, Yokohama (JP); Naoki Shimada, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/304,077

(22) Filed: Nov. 26, 2002

(30) Foreign Application Priority Data
Nov. 27, 2001 (JP) 2001-360243

(51) Int. Cl. G06F 17/60

(52) U.S. Cl. 705/35

(57) ABSTRACT

To reduce workloads given to a manager who manages computers and the like, a manager program for managing information processing apparatus is provided with a management apparatus. The manager program judges whether or not an information processing apparatus is operated within a use term based upon information of the use term of the information processing apparatus. If the manager program judges that the information processing apparatus is operated within the use term, the manager program registers a fact that the information processing apparatus corresponds to assets into a storage unit of the management apparatus, and judges whether or not the information processing apparatus is operated within the use term. If the manager program judges that the information processing apparatus is not operated within the use term, the process operation of the manager program is accomplished.

### BACKGROUND OF THE INVENTION

The present invention is related to a system capable of managing information processing equipments and the like.

As an example of assets management, for instance, JP-A-11-203349 describes an assets management system. In this assets management system, while data of assets which are intended to be managed are registered into a database, at this time, management numbers which are allocated to the assets are printed out as bar codes, and these bar codes are attached to assets products. While an inventory is carried out, an operator transmits the data of the assets products from the database to a handy terminal. The operator scans the data of the assets products which have been registered to the handy terminal, so that a date of the inventory and also the persons in charge of handling the assets products may be updated. The updated data may be reflected to the database.

Nowadays, for instance, computers have been allocated to substantially all of staff members in firms. In a case that such a large number of computers are managed as assets products, lengthy work time is necessarily required in order that an operator confirms management numbers which have been attached to the respective computers. Also, very recently, a large number of compact electronic appliances capable of having superior portability such as notebook type personal computers have been marketed. In a case that such assets products (electronic appliance) are managed, these assets products are not always set at fixed places.

Also, although main bodies and display devices (for example, main bodies and display devices such as CRTs, which constitute computers) correspond to independent assets products, both the main bodies and the display devices must be managed as one body, since the display devices cannot satisfactorily function unless the main bodies are provided.

### SUMMARY OF THE INVENTION

A first object of the present invention is to provide a system capable of managing such assets products that are not always located at fixed places.

Also, a second object of the present invention is to provide a system capable of managing assets products in relation to each other.

As one of solving means capable of achieving the above-described objects, such a manager is provided that commences management of managing subjects in response to instructions issued from these managing subjects, and ceases the management when the managing subjects are out of assets. An operator can grasp assets products by way of the manager of managing subjects.

Also, an agent is provided with a managing subject, while this agent interrogates to a manager and judges that the managing subject corresponds to an assets product based upon an interrogation result.

Furthermore, in a case that the manager ceases the management, the agent judges that the managing subject is not an assets product, and locks the managing subject in order that the managing subject cannot execute a process operation. As a result, such a managing subject which is out of assets is not utilized in an illegal manner. Also, in accordance with the present invention, loads given to the manager can be further reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram for indicating an arrangement of an assets management system according to an embodiment of the present invention.

FIG. 2 is an explanatory diagram for explaining operations of the assets management system of the embodiment.

FIG. 3 is another explanatory diagram for explaining operations of the assets management system of the embodiment.

FIG. 4 is a schematic diagram for showing an arrangement of a non-assets management server according to an embodiment of the present invention.

FIG. 5 is a schematic diagram for representing a storage content of a database employed in the assets management system of FIG. 1.

FIG. 6A and FIG. 6B are schematic diagrams for representing the storage contents of the databases.

FIG. 7 is a schematic diagram for showing an arrangement of an assets management server employed in the assets management system of FIG. 1.

FIG. 8 is a schematic diagram for indicating a storage content of another database employed in the assets management system of FIG. 1.

FIG. 9 is a diagram for illustratively showing an example of a display view employed in the assets management system of FIG. 1.

FIG. 10A and FIG. 10B are explanatory diagrams for explaining operations of a group setting process unit employed in the assets management system of FIG. 1.

FIG. 11 is a flowchart for describing process operations of a virtual manager control unit employed in the assets management system of FIG. 1.

FIG. 12 is a flowchart for explaining process operations of a contract virtual manager employed in the assets management system of FIG. 1.

FIG. 13 is a flowchart for describing process operations of a use rate virtual manager employed in the assets management system of FIG. 1.

FIG. 14 is a flowchart for explaining process operations of a depreciation virtual manager employed in the assets management system of FIG. 1.

FIG. 15 is a flowchart for describing process operations of a group virtual manager employed in the assets management system of FIG. 1.

FIG. 16 is a flowchart for explaining process operations of another virtual manager control unit employed in the assets management system of FIG. 1.

FIG. 17 is a schematic diagram for showing an arrangement of an assets agent employed in the assets management system of FIG. 1.

FIG. 18 is a flowchart for describing process operations of a management setting unit employed in the assets management system of FIG. 1.

FIG. 19 is a flowchart for explaining process operations of a management processing unit employed in the assets management system of FIG. 1.

FIG. 20 is a flowchart for describing process operations of a lock control unit employed in the assets management system of FIG. 1.

FIG. 21 is a flowchart for explaining process operations of a lock releasing unit employed in the assets management system of FIG. 1.

FIG. 22 is a schematic diagram for showing an arrangement of an assets management system according to another embodiment of the present invention.

FIG. 23 is a schematic diagram for indicating an arrangement of an assets management server employed in the assets management system of FIG. 22.

FIG. 24 is an explanatory diagram for explaining overall operations of the assets management system shown in FIG. 22.

FIG. 25 is another explanatory diagram for explaining overall operations of the assets management system shown in FIG. 22.

### DESCRIPTION OF THE EMBODIMENTS

Referring now to drawings, various embodiments of the present invention will be described.

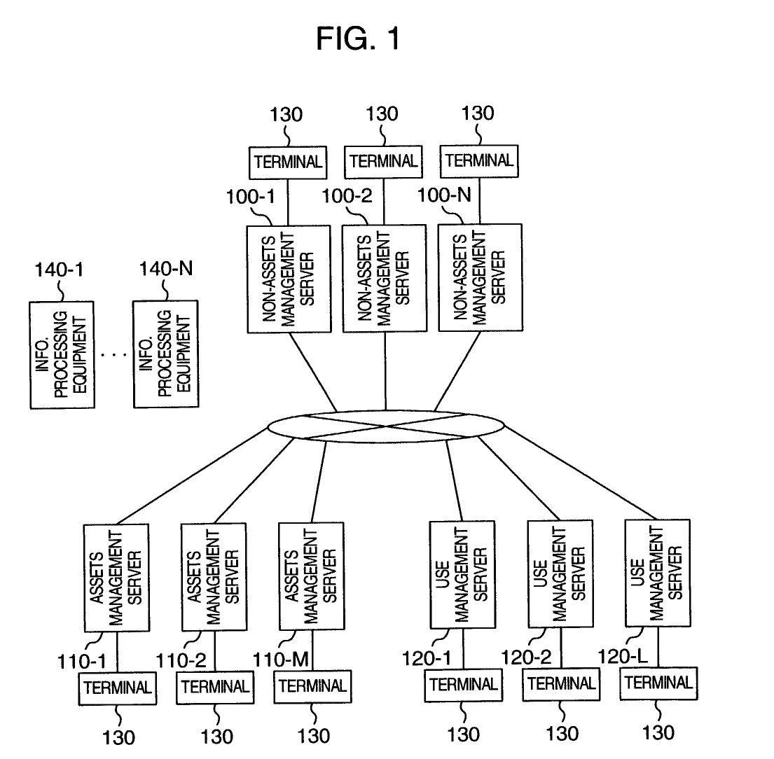

FIG. 1 is a schematic diagram for indicating a system structure of an assets management system according to an embodiment of the present invention. This assets management system contains non-assets management servers 100-1, - - - , 100-N; assets management servers 110-1, - - - , 110-M; and assets use management servers 120-1, - - - , 120-L. These servers 100, 110, and 120 are connected via a network to each other. Also, terminals 130 are connected to the non-assets management server 100, the assets management server 110, and the use management server 120, respectively, so as to be manipulated by operators. Although not shown in this drawings, either one set or plural sets of databases are connected to the respective management servers 100, 110, and 120. It is so assumed that a server whose reference numeral has no suffix may constitute a representative of relevant servers.

An assets management system according to the present invention may set any systems as management subjects, if these systems may have a communication function capable of communicating with the non-assets management server 100 and the assets management server 110, a storage function such as a memory, and a process function such as a CPU (central processing unit). For instance, an assets management system may manage, as a system equipped with these functions, OA appliances such as a computer, a printer, and a copy machine; and other appliances such as home electric appliances (will be referred to as an “information processing equipment” hereinafter which covers all of these appliances). A program called as an assets agent has been previously installed in each of information processing equipments 140-1, - - - , 140-N, which correspond to management subjects of this assets management system.

In this assets management system, the information processing equipments 140 may be managed by the non-assets management server 100 and the assets management server 110. The assets management server 110 commences assets management in response to an access issued from the information processing equipment 140. As a result, a manager of the assets management server 110 may reduce a work amount without making an inquiry to each of the information processing equipments 140.

Also, since the information processing equipment 140 makes an inquiry to the assets management server 110, this information processing equipment 140 confirms as to whether or not the own information processing equipment is under management by the assets management server 110, and if the own information processing equipment 140 is not under management by the assets management server 110, then the own information processing equipment 140 is locked so as not to be operated. As explained above, since such an information processing equipment not under management is locked, an illegal use (unfair use) can be prevented.

It should be noted that an expression “assets” used in this embodiment implies such an information processing equipment that has been purchased, or lent so as to be utilized, whereas an expression “non-assets” implies such an information processing equipment that is to be marketed, or to be lent.

Next, overall operations of the assets management system according to this embodiment mode will now be explained.

In the assets management system shown in FIG. 1, the non-assets management server 100 corresponds to such a server that is used by a person who markets, or lends the information processing equipment 140. The assets management server 110 corresponds to such a server that is used by a person who purchases, or borrows the information processing equipment 140 so as to utilize the purchased. As a consequence, since the information processing equipments 140 are marketed, or lent, such an information processing equipment that is being managed by the non-assets management server 100 may also be managed by the assets management server 110. Also, such an information processing equipment that is being managed by the assets management server 110 may also be managed by the non-assets management server 100.

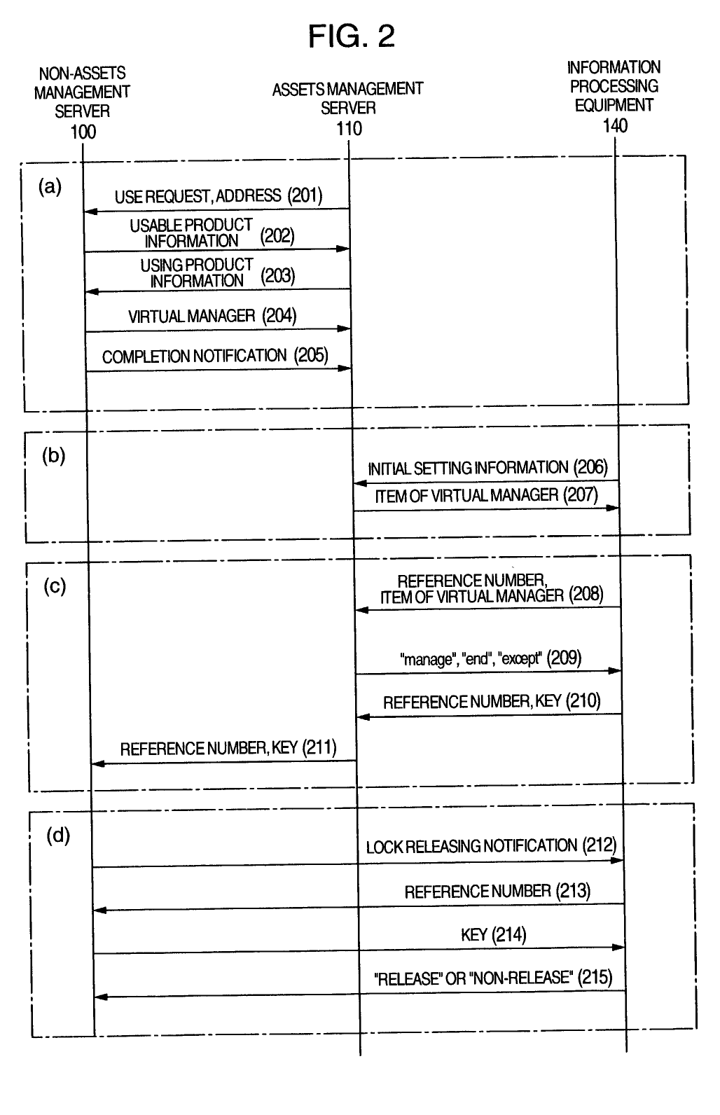

Subsequently, operations of the assets management system will now be described with reference to FIG. 2, while transmitting/receiving operations of information executed among the non-assets management server 100, the assets management server 110, and the information processing equipment 140 are mainly explained. In this example, description will now be made of such a case that the information processing equipment 140 is lent from a person who uses the non-assets management server 100 to another person who uses the assets management server 110.

FIG. 2(a) illustratively shows an application process operation for utilizing the information processing equipments 140 which have been managed by the non-assets management server 100 by using the assets management server 110.

Both a “use request” of the information processing equipment 140 and “address information” of the assets management server 110 are sent from the assets management server 110 to the non-assets management server 100 (step 201).

The non-assets management server 100 which has received the use request of the information processing equipment 140 selects a usable information processing equipment and a usable virtual manager. A virtual manager corresponds to a program used to manage an information processing equipment, the detail contents of which will be explained later.

The non-assets management server 100 sends as “usable product information”, such a list to the assets management server 110 (step 202). This list contains a product name, a condition, a manufacturing source, a technical specification, a necessary machine sort, a price, a virtual manager name, and the like, as to an information processing equipment.

The assets management server 110 selects both an information processing equipment and a virtual manager, which are utilized, and sends a reference number, a conducting mode, a use term and a use destination as “information of used product” (step 203). A reference number indicates such a number which is given to an information processing equipment at a use destination (in this case, assets management server side). The conducting mode indicates such a mode as to whether an information processing equipment is purchased, or borrowed. A use term corresponds to such a term during which an information processing equipment is borrowed.

The non-assets management server 100 registers the received information into the database, and registers the reference number into the information processing equipment. The non-assets management server 100 also registers the name of the virtual manager, if necessary. In a case that a virtual manager is selected on the side of the non-assets management server 100, the non-assets management server 100 reads out the relevant virtual manager from the database, and then sends the read virtual manager to the assets management server 110 (step 204). When the above-explained process operations are complete, the non-assets management server 100 transmits a “completion notification” to the assets management server 110, while this “completion notification” indicates that the process operations are complete (step 205). The assets management server 110 receives the completion notification, and then accomplishes the process operation.

Next, description will now be made of such a case that the information processing equipment 140 is managed by the assets management server 100.

In this assets management system, since information is transmitted from the information processing equipment 140 with respect to the assets management server 110, the managing operation may be commenced in the assets management server 100.

FIG. 2(b) indicates an initial setting operation used to manage the information processing equipment 140 by the assets management server 110.

When a power supply of the information processing equipment 140 is turned ON, this information processing equipment 140 executes the initial setting operation.

The information processing equipment 140 sends as initial setting information supplied to the assets management server 110, such information as a reference number, a use destination, a use starting date, a use term, a product name, and a name of a virtual manager (step 206). The assets management server 110 confirms as to whether or not the relevant information processing equipment issues a request based upon the received reference number, and initiates the virtual manager. Next, the assets management server 110 sends to the information processing equipment 140, an item required to perform process operations of the initiated virtual manager (step 207). For instance, in such a case that the virtual manager investigates a use rate of a CPU and a use rate of a memory in order to check as to whether or not an information processing equipment corresponds to an idle assets, the use rate of the CPU and the use rate of the memory may constitute items required to execute the process operations of the virtual manager.

The information processing equipment 140 stores the transmitted item required to execute the process operation of the virtual manager into a storage area, and thus, accomplishes the process operation of the initial setting operation.

In the assets management server 110, the virtual manager is initiated so as to manage the information processing equipment 140. For instance, in a case of such a virtual manager for managing as to whether or not the information processing equipment 140 is present within a preset term of validity, the assets management server 110 judges as to whether or not the information processing equipment 140 is present within the use term based upon a timer of the assets management server 110. When the information processing equipment 140 expires this use term, the virtual manager accomplishes the process operation. In a case that the virtual manager executes the process operation, an indication “manage” is registered into a table of the assets management server 110. In a case that the virtual manager ends the process operation, an indication “end” is registered into this table. It should also be noted that the above-described registering operation to this table will be explained later. As previously explained, the virtual manager is designed to be operated only for such a term during which the information processing equipment 140 can be effectively utilized.

FIG. 2(c) shows operations executed between the assets management server 100 and the information processing equipment 140 where the initial setting operation has been set. The assets management server 110 manages the information processing equipment 140 by the initiated virtual manager. The information processing equipment 140 makes an inquiry to the assets management server 110 in order to confirm as to whether or not the own information processing equipment 140 corresponds to valid assets.

The information processing equipment 140 regularly sends a reference number and data about an item required to execute process operation of a virtual manager (step 208). The assets management server 110 confirms as to whether or not the virtual manager which manages this information processing equipment 140 executes the process operation based upon the sent reference number. In a case that the virtual manager executes the process operation, the assets management server 110 transmits “manage” to the information processing equipment 140; in such a case that the virtual manager accomplishes the process operation, the assets management server 110 transmits “end” to the information processing equipment 140; and in such a case that the virtual manager is out of the process operation, the assets management server 110 transmits “except” to the information processing equipment 140 (step 209). When the information processing equipment 140 receives “manage”, this information processing equipment 140 judges that the own information equipment 140 is managed by the assets management server 110, and after preselected time has passed, the information processing equipment 140 again transmits the reference number and the item required to execute the process operation by the virtual manager to the assets management server 110 (step 208). When the information processing equipment 140 receives “except”, the information processing equipment 140 judges that the own information processing equipment 140 is out of management by using the assets management server 110. In this case, the information processing equipment 140 performs no specific process operation.

On the other hand, when the information processing equipment 140 receives “end”, this information processing equipment 140 judges that the management executed in the assets management server 110 is ended. The information processing equipment 140 which judges that the management executed by the assets management server 110 has been ended locks the operation of the own information processing equipment 140 in order that the user cannot use this information processing equipment 140, and also, produces a key used to release this locking operation. Then, the information processing equipment 140 sends both the reference number and the produced key to the assets management server 110 (step 210). The assets management server 110 which has received both the reference number and the produced key transmits both the reference number and the key to the non-assets management server 100 (step 211). It should be noted that in this case, a key corresponds to such a key which has been encrypted by a public key of an information processing equipment, and this encrypted key cannot be decrypted by the assets management server 110 which has not a secret key. It should also be noted that such operations of the information processing equipment 140 are executed by an assets agent stored in this information processing equipment 140.

As explained above, the assets management server executes the managing operation in response to the inquiry issued from the information processing equipment. As a result, the manager need not go to confirm the information processing equipment, or need not access the information processing equipment via the communication line, so that the load given to the manager can be reduced.

Also, in such a case that a user of the non-assets management server lends an information processing equipment by setting a time limit, since the information processing equipment locks the own information processing equipment when the time limit has elapsed, there is no possibility that the information processing equipment is not utilized after the time limit has elapsed.

When the use time of the information processing equipment is terminated, this information processing equipment is returned.

FIG. 2(d) indicates such a process operation that the locking condition is released in order that the returned information processing equipment may be again used. The non-assets management server 100 transmits a locking release notification to the information processing equipment 140 (step 212). The information processing equipment 140 which has received the locking release notification sends such a reference number capable of specifying the own information processing equipment to the non-assets management server 100. Then, the non-assets management server 100 reads out the encrypted key which has been acquired in FIG. 2(c) from the transmitted reference number, and then decrypts this read key based upon the secret key. The non-assets management server 100 sends this decrypted key to the information processing equipment 140 (step 214). The information processing equipment 140 releases the locking condition by using the transmitted decrypted key, and sends “release” when the locking condition is released, or sends “not released” when the locking condition is not released to the non-assets management server 100 (step 215).

In FIG. 2, description has been made of such a case that the information processing equipment was borrowed. Now, in such a case that a person who owns the assets management server 110 purchases the information processing equipment, the assets management server 110 need not send both the reference number and the key, shown in FIG. 2(c), to the non-assets management server 100. In this case, the non-assets management server 100 sends such a secret key used to decrypt the key to the assets management key 110 in order that the locking condition of the information processing equipment can be released by the assets management server 110. Otherwise, if the information processing equipment does not encrypt the key, the assets management server 110 can release the locking condition.

It should also be noted that description has been made of one non-assets management server in FIG. 2, but, even when a plurality of non-assets management servers are employed, similar process operations may be carried out.

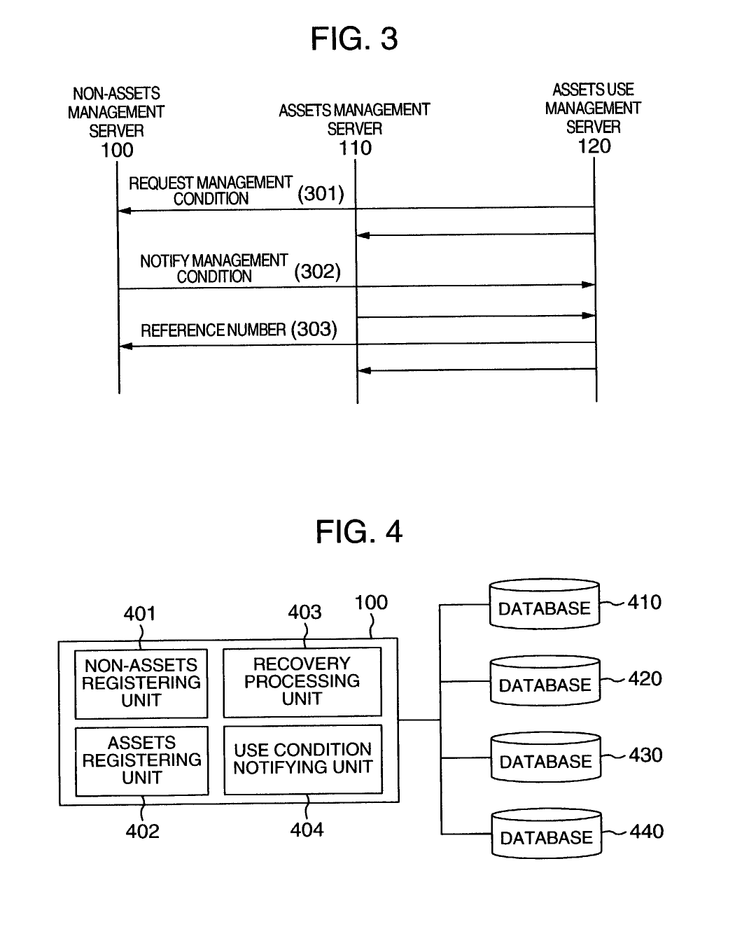

FIG. 3 represents assets managing operation executed by the assets use management server 120.

The assets use management server 120 notifies to send respective managing conditions of an information processing equipment from both the non-assets management server 100 and the assets management server 110 (step 301). In this case, a managing condition of a non-assets management server corresponds to a reference number used to specify an information processing equipment, information for indicating as to whether or not this information processing equipment is contained, information of a use destination of this information processing equipment, and the like. Also, a managing condition of an assets management server corresponds to a reference number used to specify an information processing equipment, information for indicating as to whether or not this information processing equipment is contained, information of a use source. When the assets use management server 120 receives the managing conditions from the non-assets management server 100 and the assets management server 110 (step 302), this assets use management server 120 compares both the managing conditions with each other, and then confirms as to whether or not the managing condition of the non-assets management server 100 is made coincident with the managing condition of the assets managing server 110. For instance, in such a case that information processing equipments having the same reference numbers are owned by both a non-assets management server and an asset management server, a managing condition of the non-assets management server is made coincident with a managing condition of the assets management server. In this case, the assets use management 120 transmits the reference numbers of the information processing equipments which are made coincident with each other to both the assets management server 100 and the non-assets management server 110 (step 303).

There are some cases that information processing equipments are borrowed from users of a plurality of non-assets management servers 100 in the assets management servers 110. In this case, the assets use management server 120 may specify the non-assets management server 100 from the information related to the use source of the management condition sent from the assets management server 110, and may notify the specified non-assets management server 100 to send the managing condition.

As previously explained, since the use management server manages as to whether or not the managing operation of the information processing equipment is performed in the correct manner, the managing operations can be correctly carried out in the non-assets management server and the assets management server.

Subsequently, each of management servers and each of assets agents will now be described.

FIG. 4 represents both the non-assets management server 100 and databases 410 to 440 connected to this non-assets management server 100.

The non-assets management server 100 corresponds to such a server which manages the information processing equipments 140, and also contains a non-assets registering unit 401, an assets registering unit 402, a recovery processing unit 403, and a use condition notifying unit 404. The non-assets registering unit 401 registers an information processing equipment into the databases 410 and 420. The assets registering unit 402 registers such an information processing equipment which constitutes “assets” into the databases 410 and 420. The recovery processing unit 403 recovers a locked information processing equipment. The use condition notifying unit 404 notifies the storage contents of the databases 410 and 420 to the assets use management server 120. Operations of the respective units will be explained later.

Also, databases 410, 420, 430, which register thereinto information related to information processing equipments, and also, another database 440 are connected to the non-assets management server 100. The database 440 registers a virtual manager into an information processing equipment.

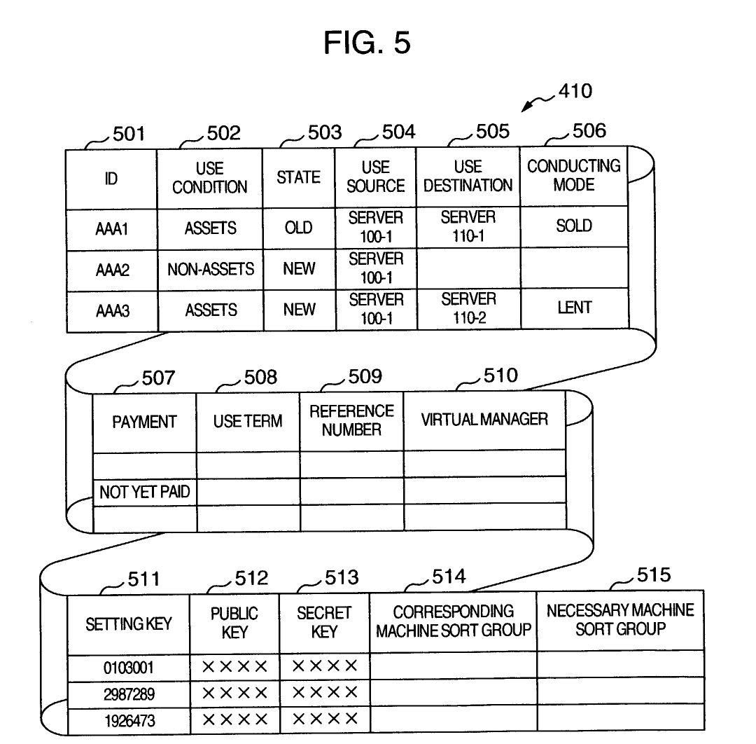

FIG. 5 represents a storage content of the database 410. The information related to the information processing equipments which are managed by the non-assets management server 100 has been registered in this database 410. This database 410 registers an ID 501 used to specify an information processing equipment, a use condition 502, a state 503, a use source 504, a use destination 505, a conducting mode 506, a payment 507, a use term 508, a reference number 509, a virtual manager 510, a setting key 511, a public key 512, a secret key 513, a corresponding machine sort group 514, and a necessary machine sort group 515. As to the use condition 502, “assets”, “non-assets” are registered. As to the state 503, “new” is registered in the case that an information processing equipment is not utilized, whereas “old” is registered in the case that a used information processing equipment is again utilized. As to the use source 504, both a registering person who has registered data into the database 410, and also, an address of a server are registered. As to the use destination 505, both a name of a selling destination, or a name of a lending destination, and an address of a server are registered (in this case, address of non-assets management server 100 is registered). As to the conducting mode 506, either “sold” or “lent” is registered. As to the payment 507, such a fact as to whether or not a fee is paid when either “sold” or “lent” is performed is registered. As to the use term 508, a term which has been determined in the case of “lent” is registered. In a case that the term is not determined, no registration is carried out. As to the reference number 509, numbers are registered which are applied to the respective information processing operations at use destinations. As to the virtual manager 510, a name of a virtual manager is registered. It should also be noted that this virtual manager will be explained later. As to the setting key 511, a key for releasing a locking condition of an information processing equipment is registered. As to the public key 512 and the secret key 513, such an item for encrypting, or decrypting the respective keys is registered.

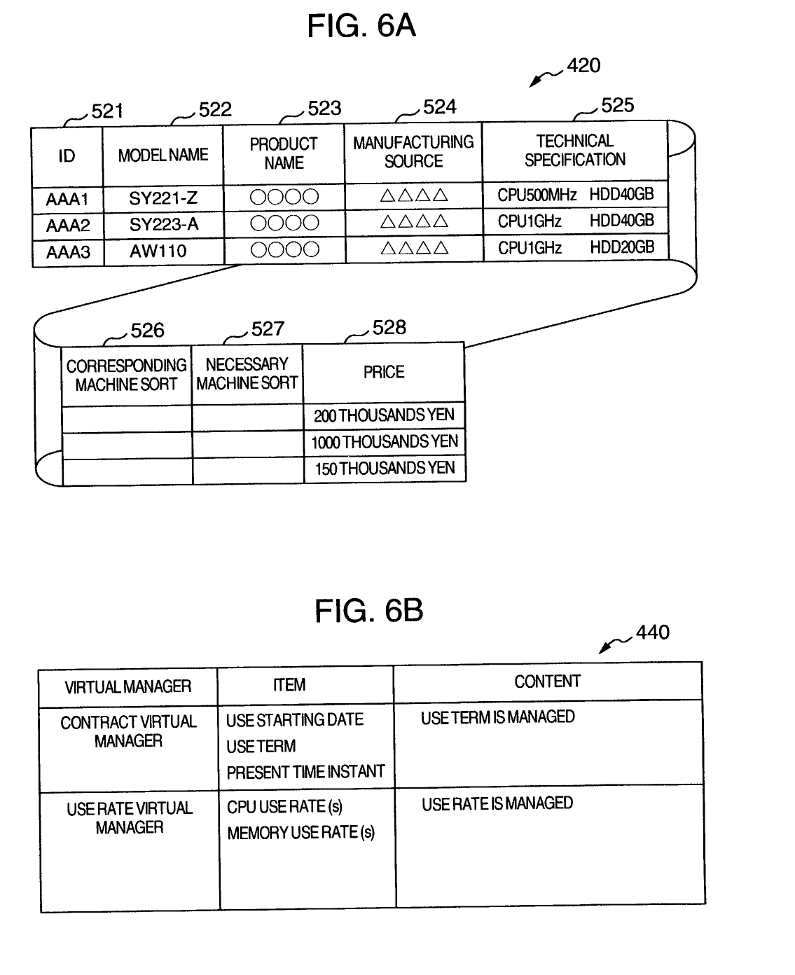

FIG. 6A indicates a storage content of the database 420. In this database 420, an ID 521 for specifying each of information processing equipments; a model name 522 of an information processing equipment; a product name 523 thereof; a manufacturing source 524 thereof; a technical specification 525 thereof; a corresponding machine sort 526; a necessary machine sort 527; and a price 528 thereof are registered. The ID 521 is identical to the ID 501 of the database 410. As to the manufacturing source 514, both a name of the manufacturing source and an address of a management server for the manufacturing source are registered. As to the corresponding machine sort 526, either a product name or a model name, which can be utilized in this information processing equipment, is registered. As to the necessary machine sort 527, either a product name or a model name is registered, which are required so as to utilize this information processing equipment and which can be utilized as another information processing equipment.

In the database 430, the data of the database 410 is registered. Since the database 410 indicates a present state of an information processing equipment, the storage contents of the database 410 such as the use condition 502, the use destination 505, and the use term 508 are changed every time the information processing equipment is repeatedly sold, or lent. Every time the content of the database 410 is changed, this changed data is registered into the database 430. As a result, a history is registered in the database 430, so that a manager can know such a past fact that how the information processing equipment was utilized.

FIG. 6B shows a storage content of the database 440. A virtual manager, a content of a process operation executed by the virtual manager, and a data item required for the virtual manager are registered in the database 440. The virtual manager corresponds to a program used to manage an information processing equipment. As this virtual manager, there are a contact virtual manager and an idle virtual manager. The contact virtual manager manages as to whether or not, for instance, the information processing equipment is utilized within a predetermined period. The idle virtual manager manages as to whether or not the information processing equipment corresponds to the idle assets.

Returning back to FIG. 4, operations of the respective units employed in the non-assets management server 100 will now be explained.

The non-assets registering unit 401 registers such an information processing equipment that constitutes non-assets into the databases 410 and 420.

As a method for registering information processing equipments corresponding to the non-assets, there are two methods, namely, a method for acquiring a list such as product names and model names of the information processing equipments via either a recording medium such as a floppy disk or via a network; and another method for entering this list by using an input device such as a keyboard by an operator. Since the process operations of the non-assets registering unit 401 are carried out, the ID 501 of the database 410, the ID 521 of the database 420, the use condition 502, the state 503, the model name 522, the product name 523, the manufacturing source 524, the technical specification 525, the corresponding machine sort 526, the necessary machine sort 527, and the price 528 are registered. It should also be noted that at this time, the condition is registered as “non-assets” in the use condition 502.

Next, description will now be made of process operations of the assets registering unit 402. Since the assets registering unit 402 is employed so as to execute the process operations shown in FIG. 2(a), the above-described process operations will now be described with reference to FIG. 2(a).

The “use request (step 201)” sent from the assets management server 110 is mainly divided into a use request of an information processing equipment; a use request of a virtual manager; and also, a use request of both an information processing equipment and a virtual manager.

In a case that a request corresponds to the use request of the information processing request, the assets registering unit 402 reads out an information processing equipment which can be utilized from the databases 410 and 420. When the information processing equipment is read, an ID, a model name, a product name, a state, a manufacturing source, a technical specification, a corresponding machine sort, a necessary machine sort, and a price as to such an information processing equipment are read out which has been registered as “non-assets” into the use condition 502 of the database 410. Also, in the case that a request corresponds to the use request of the virtual manager, a name of a registered virtual manager is read out from the database 440.

The assets registering unit 402 sends as “usable product information (step 201)” to the assets management server 110 in a list format, the ID, the model name, the product name, the state, the manufacturing source, the technical specification, the corresponding machine sort, the necessary machine sort, the price, and the virtual manager name, which have been read in the above-described manner.

When the assets registering unit 402 receives “using product information (step 203)” from the assets management server 110, this assets registering unit 402 registers this received information into the database 410. Since the ID, the reference number, the use destination, the use term, the product name, the use starting date, and the virtual manager name are contained in “using product information” sent from the assets management server 110, the assets registering unit 402 registers these various data into the database 410 based upon the ID. At this time, the indication “assets” is registered in the use condition 502 of the ID which is set as the using product information. As previously explained, since the indication “assets” is registered in the use condition, it is so indicated that this information processing equipment is out of management by the non-assets management server 100. Also, the data as to the information processing equipment which has been registered as “assets” in the use condition is registered as history data into the database 430.

Next, in a case that the virtual manager name is contained in the using product information transmitted from the assets management server 101, the assets registering unit 402 reads out the requested virtual manager from the database 440, and then, sends the read virtual manager to the assets management server 110 which has issued the request. Finally, “completion notification (step 205)” is notified to the assets management server 110, and the process operation is complete.

As previously explained, since the reference number and the use destination of the information processing equipment managed by the assets management server 110 are registered in the non-assets management server 100, the non-assets management server 100 can manage where the information processing equipment is utilized. Also, since the virtual manager for managing the information processing equipment can be sent, such a cumbersome operation can be omitted. That is, a program used to manage the information processing equipments is formed on the side of the assets management server.

Next, process operation executed in the recovery processing unit 403 will now be explained. This process operation is realized by executing the process operations shown in FIG. 2(d), and corresponds to such a process operation that a locked information processing equipment may be again utilized. In this case, this process operation will be explained with reference to FIG. 2(d).

The non-assets management server 100 sends a notification to the information processing equipment 140 so as to perform a recovery (step 212). Based upon this notification, the information processing equipment 140 sends the reference number to the non-assets management server 100 (step 213). The recovery processing unit 403 of the non-assets management server 100 reads out both the encrypted key and the secret key, which correspond to the reference number, from the database 410 based upon the reference number received from the information processing equipment 140, and then decrypts the encrypted key based upon the secret key. The recovery processing unit 403 of the non-assets management server 100 sends this decrypted key to the information processing equipment 140. The information processing equipment 140 which has received the decrypted key transmits “release” in a case that the locking condition is released to the non-assets management server 100, or sends “non-release” in a case that the locking condition cannot be released to this non-assets management server 100.

The recovery processing unit 403 which has received the notification of “release” registers “nonassets” into the use condition of this information processing equipment 140, and also registers “old” into the condition thereof. On the other hand, the recovery processing unit 403 which has received “release not allowable” displays both a reference number and an ID on the display device. This implies such a case that the encrypted key which is sent from the assets management server 110 is different, or the information processing equipment is different. As a result, the information processing equipment can be managed in the correct manner by the assets management server 110.

As shown in FIG. 3, when the use condition notifying unit 404 receives the notification of the management condition from the assets use management server 120, this use condition notifying unit 404 sends the use condition, the use destination, the use term, the reference number, and the product name from the database 410 to the use management server 120. When the use condition notifying unit 404 receives such an incoincident reference number of an information processing equipment from the use management server 120, the use condition notifying unit 404 displays both a reference number and a product name on a terminal.

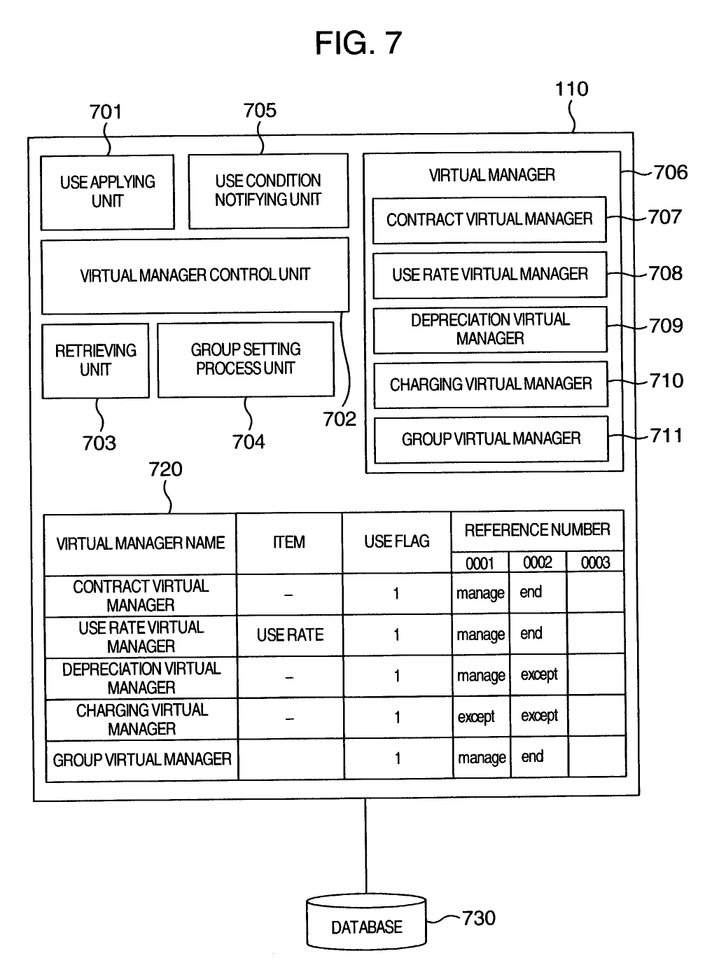

FIG. 7 shows both the assets management server 110 and a database 730 connected to this assets management server 110.

The assets management server 110 is employed so as to manage either a purchased information processing equipment or a borrowed information processing equipment as “assets”, and contains a use application unit 701, a plurality of virtual managers 706, a virtual manager control unit 702, a retrieving unit 703, a group setting process unit 704, and a use condition notifying unit 705. The use application unit 701 applies either a purchase request or a borrow request of an information processing equipment. The virtual manager control unit 702 manages an information processing equipment by utilizing a virtual manager. The retrieving unit 703 retrieves both the database 730 and the virtual manager management table 720. The use condition notifying unit 705 notifies a storage content of the database 730 to the assets use management server 120. In this case, this assets management server 110 contains a contract virtual manager 707, a use rate virtual manager 708, a depreciation virtual manager 709, a charging virtual manager 710, and also a group virtual manager 711. These virtual managers are read out from other apparatus, and/or are produced by the assets management server 110.

Also, the assets management server 110 contains a virtual manager management table 720 which indicates a relationship between a virtual manager and an information processing equipment managed by the virtual manager. This virtual manager management table 720 stores thereinto names of virtual managers owned by the assets management server 110, an item required to be managed by a virtual manager, a use flag indicative of an actually-used virtual manager, and also, a reference number of an information processing equipment managed by a virtual manager. In a case that the information processing equipment is managed by the virtual manager, the indication “manage” is stored in this virtual manager management table 720; in a case that the management is ended, the indication “end” is stored in this virtual manager management table 720; and in a case that the information processing equipment is out of management, the indication “except” is stored into the virtual manager management table 720.

Operation of the respective units will be discussed later.

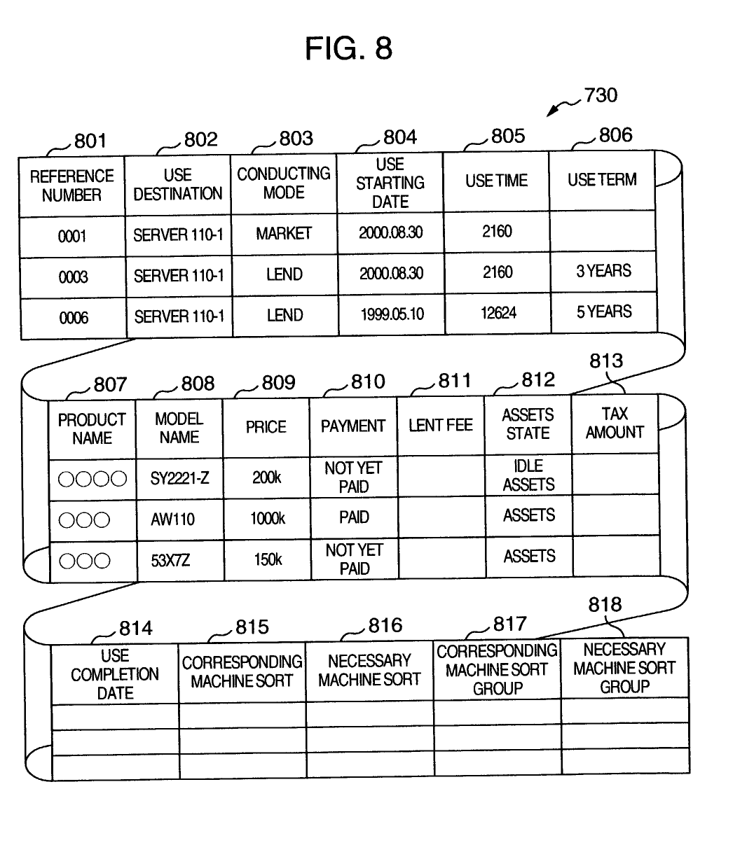

FIG. 8 indicates a storage content of the above-described database 730. In this database 730, the following items are registered, namely, a reference number 801; a use destination 802; a conducting mode 803; a use starting date 804; a use time 805; a product name 807; a model name 808; a price 809; a payment 810; a rental fee 811; an assets state 812; a tax amount 813; a use completion date 814; a corresponding machine sort 815; a necessary machine sort 816; a corresponding machine sort group 817; a necessary machine sort group 818, and the like. In this case, the reference number 801, the use destination 802, the conducting mode 803, the use term 806, the product name 807, the model name 808, the price 809, and the payment 810 are the same as the use term, the use destination, the conducting mode, the reference number, the product name, the price, and the payment, which have been registered in the databases 410 and 420 shown in FIG. 5 and FIG. 6A. The use starting date 804 corresponds to a date on which a use of an information processing equipment is started. The use time 805 indicates such time counted since the use of the information processing equipment has been started. The use end time 814 shows a date on which the use of the information processing equipment is ended. The rental fee 811, the assets state 812, and the tax amount 813 are registered by a virtual manager. If there is another virtual manager different from the virtual manager shown in FIG. 7, then an item to be registered is newly added. The corresponding machine sort group 817 is to register a reference number of an information processing equipment which may be utilized by this information processing equipment. The necessary machine sort group 818 is to register a reference number of an information processing equipment which is required to use this relevant information processing equipment. The corresponding machine sort group 817 and the necessary machine sort group 818 may be registered by either the manager of the assets management server 110 or the user of the information processing equipment from the terminal. Alternatively, the corresponding machine sort group 817 and the necessary machine sort group 818 may be registered by the manager of the non-assets management group 100, or may be automatically set by executing the group setting process unit 704 (will be explained later).

Returning back to FIG. 7, operation of the assets management server 110 will now be explained.

Description will now be made of process operations of the use application unit 701. The use application unit 701 executes the process operation shown in FIG. 2(a). In this case, the process operation of this use application unit 701 is explained with reference to FIG. 2(a).

The operator initiates the use application unit 701 from the terminal. The operator sends as “use request” to the non-assets management server 100, such an information as to whether or not an information processing equipment is used, whether or not a virtual manager is used, or whether or not both the information processing equipment and the virtual manager are used.

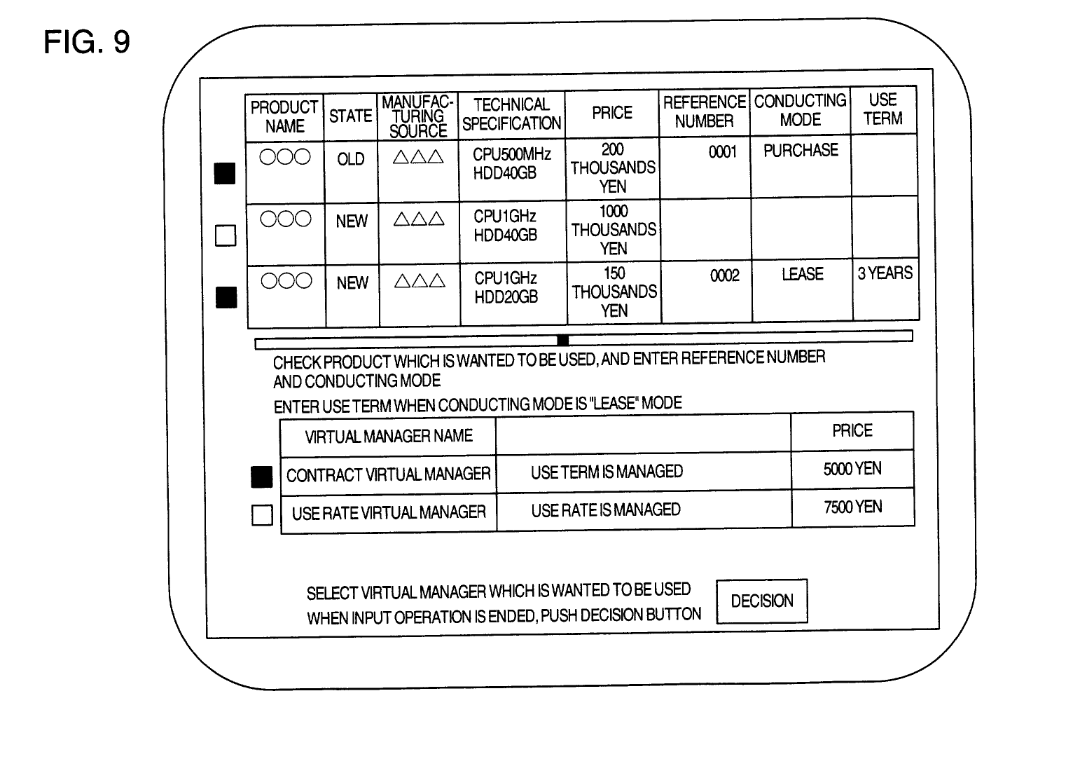

In the use application unit 701, a product name; a state; a manufacturing source; a technical specification; a corresponding machine sort; and a virtual manager name are displayed on the terminal, which are sent as the usable product information from the non-assets management server 100. FIG. 9 indicates an example of a view on a display screen. On the view shown in FIG. 9, both the information processing equipment and the virtual manager are designated as “use request”, and further, this view displays thereon the product name, the state, the manufacturing source, the technical specification, the price, the virtual manager name and so on. It should be understood that although such items as the corresponding machine sort and the necessary machine sort are not displayed on this view, these items may be displayed in a scroll manner. Also, a reference number, a conducting mode, and a use term correspond to such items which are inputted by an operator. The reference number corresponds to a use destination, namely, a number given to an information processing equipment. As to the conducting mode, the operator inputs such an information as to whether an information processing equipment is purchased, or borrowed. In a case that an information processing equipment is borrowed, an input of the use term becomes valid, and then, the operator inputs desirable term. Also, the operator may select a virtual manager which is wanted to be used by this operator.

When the operator pushes a button of “decide” displayed on the view, the items shown in FIG. 9 are sent as “using product information” to the non-assets management server 100 (step 203).

Also, when the use application unit 701 receives a virtual manager from the non-assets management server 100 (step 204), this use application unit 701 registers the transmitted virtual manager. When the use application unit 701 receives a completion notification, this use application unit 701 registers into the database 730, a reference number; a use destination; a conducting mode; a use term; a product name; a price; a corresponding machine sort; and a necessary machine sort as to an information processing equipment which is selected on the screen.

Next, process operation of the group setting process unit 704 will now be explained.

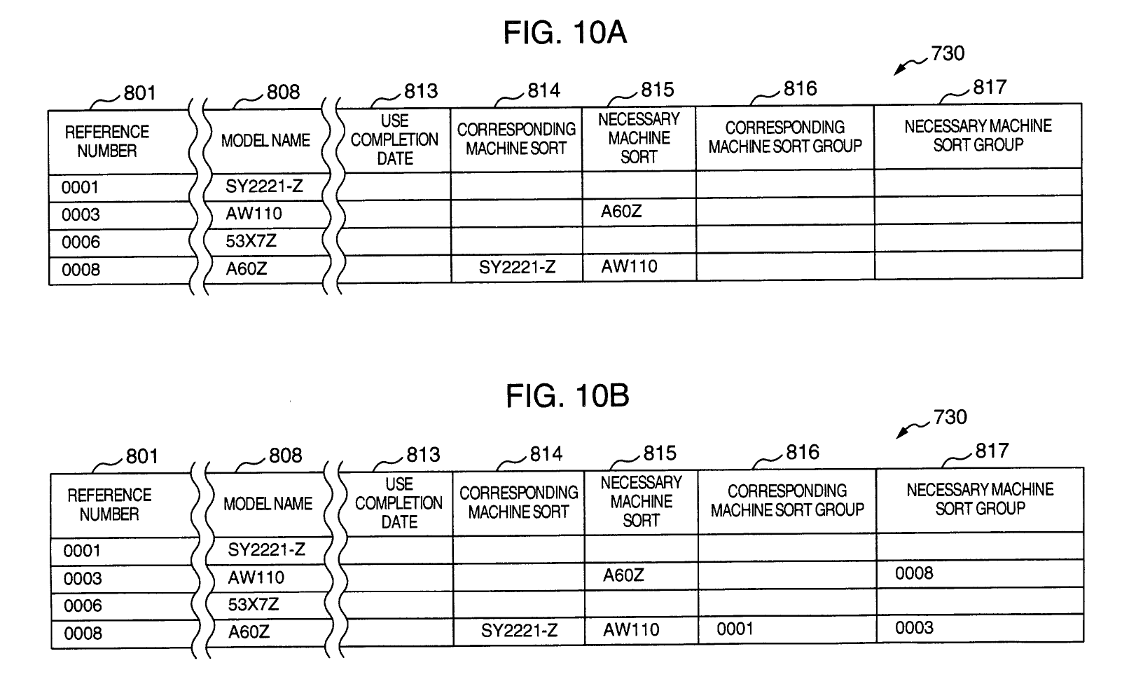

FIG. 10A and FIG. 10B show a partial content of the database 730. It is so assumed that, as shown in FIG. 10A, the necessary application items have been registered into the database 730 by the use application unit 701. The group setting process unit 704 selects one of the registered plural information processing equipments. Next, while a model name of the selected information processing equipment is used as a key, the group setting process unit 704 retrieves both the corresponding machine sorts and the necessary machine sorts of the plural information processing equipments are retrieved. As a result of this retrieve condition, when the model name of the selected information processing equipment is registered in the corresponding machine sort and the necessary machine sort, the group setting process unit 704 registers a reference number of the selected information processing equipment into both a corresponding machine sort group and a necessary machine sort group of the retrieved plural information processing equipments. In other words, in a case that a reference number “0001” of FIG. 10A is selected, while a model name “SY2221-Z” of this information processing equipment is used as a key, the group setting process unit 704 executes the retrieving operation with respect to the corresponding machine sorts and the necessary machine sorts of other reference numbers. As a result of this retrieving operation, since the model name “SY2221-Z” has been registered in a corresponding machine sort of a reference number “0008”, this reference number “0008” is outputted as a retrieved result. Next, the group setting process unit 704 registers the selected reference number “0001” into the corresponding machine sort group of the reference number “0008”. FIG. 10B indicates such a result obtained by performing this process operation with respect to all of the information processing equipments. As explained above, either the correspondence relationship or the necessary relationship can be registered with respect to the information processing equipments registered in the database 730 by the group setting process unit 704.

Next, the retrieving process unit 703 is explained. The retrieving process unit 703 accepts a retrieve key, retrieves the storage content of the database 730, and outputs a retrieved result. The retrieve key and the retrieving subject correspond to both the items registered in the database 730 and the items of the virtual manager management table 720. Also, the output of the retrieved result corresponds to the content registered into the database 730 and the content registered into the virtual manager management table 720. Also, several items may be combined with each other so as to be used as the retrieve key, and also as the retrieving subject. As a result, either the manager of the assets management server 110 or the user of the information processing equipment may judge the processing result of the information processing equipment. For instance, while a reference number of an information processing equipment is employed as a retrieve key by using the retrieving process unit 703, if the reference number is the retrieving subject, then both a corresponding machine sort group 817 and a necessary machine sort group 818 of such an information processing equipment corresponding to the retrieve key are displayed. In this case, if none of items has been registered into both the corresponding machine sort group 817 and the necessary machine sort group 818 are registered, then either the manager or the user can understand that the assets management server 110 does not contain the corresponding information processing equipment, and the required information processing equipment. Also, in such a case that an information processing equipment is newly conducted, while either a model name or a product name of this information processing equipment is employed as a retrieve key, the retrieving process unit 703 can retrieve either corresponding machine sorts or necessary machine sorts. As a result, either the manager or the user can judge as to whether or not there is such an information processing equipment corresponding to the information processing equipment which is newly conducted.

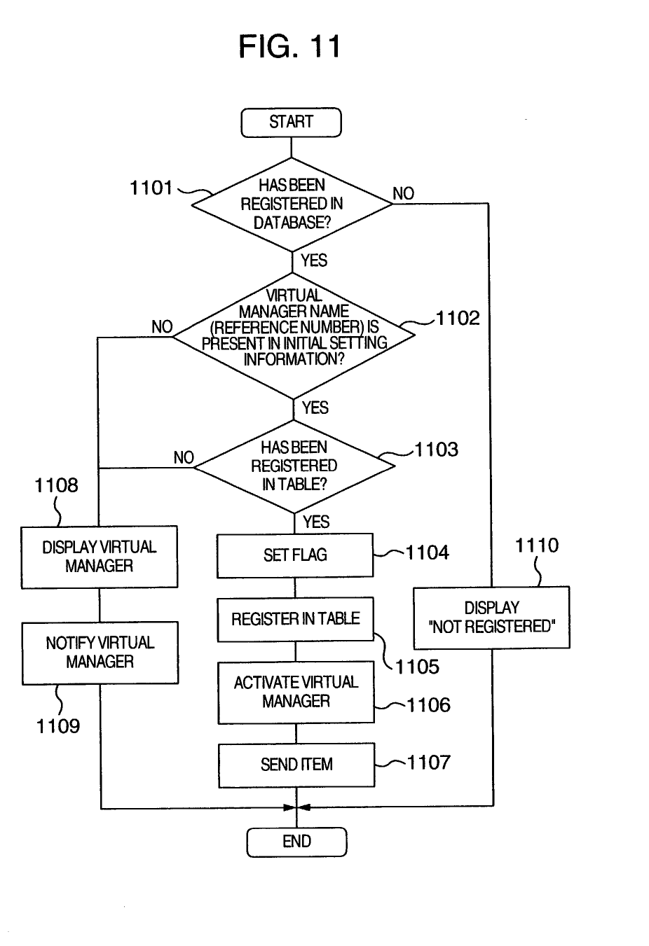

FIG. 11 indicates process operation of an initial setting operation executed by the virtual manager control unit 702. This initial setting process operation is to execute the process operation shown in FIG. 2(b).

The virtual manager control unit 702 confirms as to whether or not the reference number received as the initial setting information from the initial processing apparatus has already been registered into the database 730 (step 1101). The reference numbers have been registered into this database 730 in connection with the information processing equipments which are used in the use application process operation of FIG. 2(a). As a result, since the virtual manager control unit 702 confirms as to whether or not the reference number sent from the information processing equipment has been registered into the database 730, this virtual manager control unit 702 can confirm as to whether or not this reference number is the same as such a reference number whose use is requested. In a case that this sent reference number has not yet been registered in the database 730 (“NO” in process step 1101), the virtual manager control unit 702 displays “unregistered” on the terminal in connection with the sent reference number (step 1110). In a case that this sent reference number has been registered in the database 730 (“YES” in process 1101), the virtual manager control unit 702 judges as to whether or not a virtual manager is transmitted as the initial setting information (step 1102). When the virtual manager is transmitted (“YES” in step 1102), the virtual manager control unit 702 confirms as to whether or not this virtual manager has been registered into the virtual manager management table 720 (step 1103). When this sent virtual manager has been registered (“YES” in step 1103), the virtual manager control unit 702 sets a flag for indicating that the virtual manager is utilized (step 1104). Such a case that this sent virtual manager has not yet been registered will be explained later. Next, the virtual manager control unit 702 registers the reference number of the information processing equipment in the virtual manager management table 720 (step 1105), and then, initiates such a virtual manager to which the flag has been set (step 1106). This flag indicates the use of the virtual manager management table 720. Next, the virtual manager control unit 702 reads a necessary item into the virtual manager to which the flag has been set, and sends the resulting virtual manager to the information processing equipment (step 1107), and then accomplishes the initial setting process operation.

On the other hand, in a case that the virtual manager control unit 702 judges that the sent virtual manager is not registered (“NO” in process step 1103), this virtual manager control unit 702 displays a name of the virtual manager on the terminal connected to the assets management server 110 (step 1108), and notifies both the name of the virtual manager and such a fact that this virtual manager is not registered to the information processing equipment (step 1109), and then accomplishes the process operation.

As previously explained, when the initial setting information is received from the information processing equipment, the virtual manager of the assets management server 110 is executed so as to manage the information processing equipment. The virtual manager to be executed may be executed by setting the use flag of the virtual manager management table 720 shown in FIG. 7. In this case, the virtual manager to be executed may be designated also from the information processing equipment.

As previously described, the virtual manager management table 720 represents as to whether or not the virtual manager manages the information processing equipment by employing such indications “manage”, “except”, and “end”. The indication “manage” shows that the information processing equipment is managed; the indication “except” indicates that the information processing equipment is out of management; and the indication “end” represents that the management is ended. As a consequence, as to the management subject, the state is transferred from “manage” to “end”. Also, in such a case that the reference number has been registered and any one of these indications “manage”, “except”, and “end” has not yet been registered, this indicates such a condition that the virtual manager control unit 702 does not judge as to whether or not the virtual manager manages the information processing equipment.

Also, in a case that even one is registered as “end”, this information processing equipment is locked and thus cannot be used.

Next, description will now be made of the contract virtual manager 707, the use rate virtual manager 708, the depreciation virtual manager 709, the charging manager 710, and the group virtual manager 711, which are shown in FIG. 7.

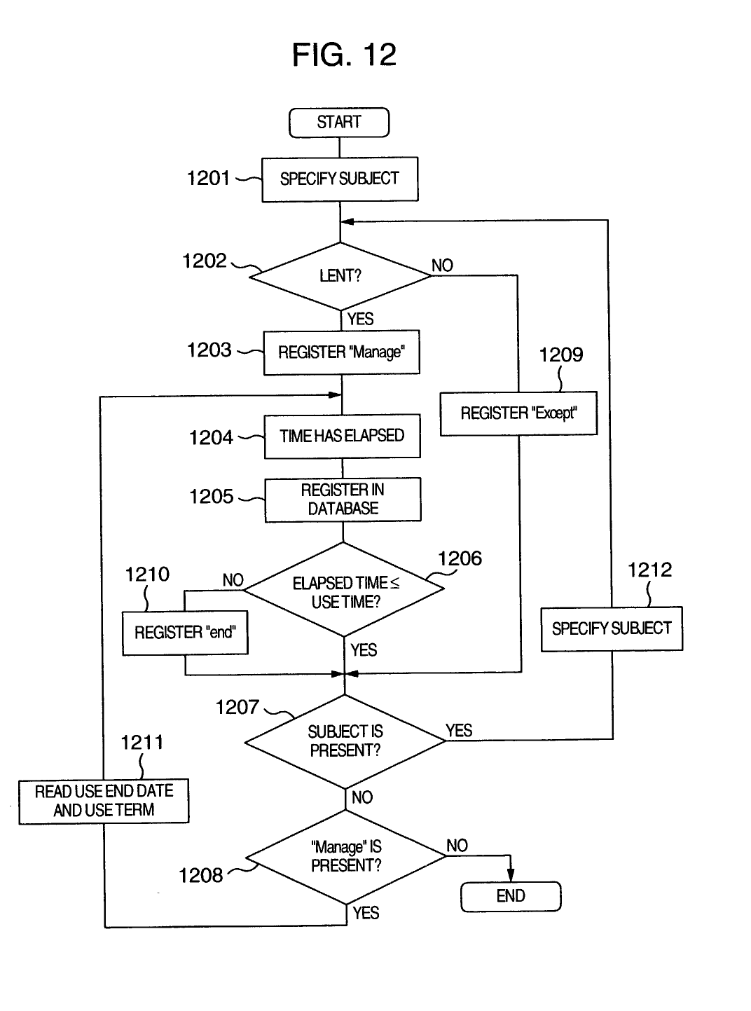

When an information processing equipment is borrowed with a time limit, the contract virtual manager 707 corresponds to such a virtual manager for managing this time limit. FIG. 12 represents process operations of the contact virtual manager 707.

The contract virtual manager 707 specifies such a reference number as a subject to be processed, and reads out a conducting mode, a use starting date, and a use term of this reference number from the database 730 (step 1201). As to this reference number, any one of these indications “manage”, “except”, “end” is not registered in a column of the contract virtual manager of the virtual manager management table 720. In this case, when such an indication “lend” is not registered as the conducting mode (“NO” in process step 1202), the indication “except” is registered in a column of the contract virtual manager by this reference number of the virtual manager management table 720 (step 1209). In other words, when an information processing equipment is newly purchased, since this purchased information processing equipment is out of the management by the contract virtual manager, this information processing equipment is registered as “except”.

On the other hand, in a case that the indication “lend” has been registered (“YES” in process step 1202), the contract virtual manager 707 registers the indication “manage” (step 1203), and calculates elapse time from both the derived use starting date and the present date obtained from the assets management server 110 (step 1204), and then, registers the calculated elapse time into the database 730 (step 1205). In the case that the elapse time exceeds the use time (“NO” in process step 1206), the indication “end” is registered in this reference number of the virtual manager management table 720 (step 1210). When the elapse time is located within the use time (“YES” in process step 1206), the contract virtual manager 707 checks as to whether or not such a reference number to which any one of these indications “manage”, “except”, “end” has not been registered is present in a column of the contract virtual manager of the virtual manager management table 720 in a similar manner to that of the above-described process step 1201 (step 1207). When the check result becomes “YES” in this process step 1207, the contract virtual manager 707 specifies this reference number as the processing subject, and thus, reads out a conducting mode, a use starting date, and a use term of this reference number from the database 730 (step 1212).

In a case that there is no subject to be processed (“NO” in process step 1207), the contract virtual manager 707 checks as to whether or not there is such a reference number which has been registered as “manage” in a column of the contract virtual manager in the virtual manager management table 720 (step 1208). When there is the reference number registered as “manage” (“YES” in process step 1208), the contract virtual manager 707 waits for a preselected time period, and then, reads out both a use term and a use starting date as to this reference number from the database 730 (step 1211), and then, the process operation is returned to the previous step 1204. To the contrary, in the case that there is no reference number registered as “manage” (“NO” in process step 1208), the process operation is accomplished.

As previously explained, the contract virtual manager regularly checks as to whether or not an information processing equipment is used within the use term, and accomplishes the management when the use term has passed. In a case that the contract virtual manager manages a plurality of information processing equipments, the contract virtual manager accomplishes the process operation when the management is accomplished as to all of the information processing equipments.

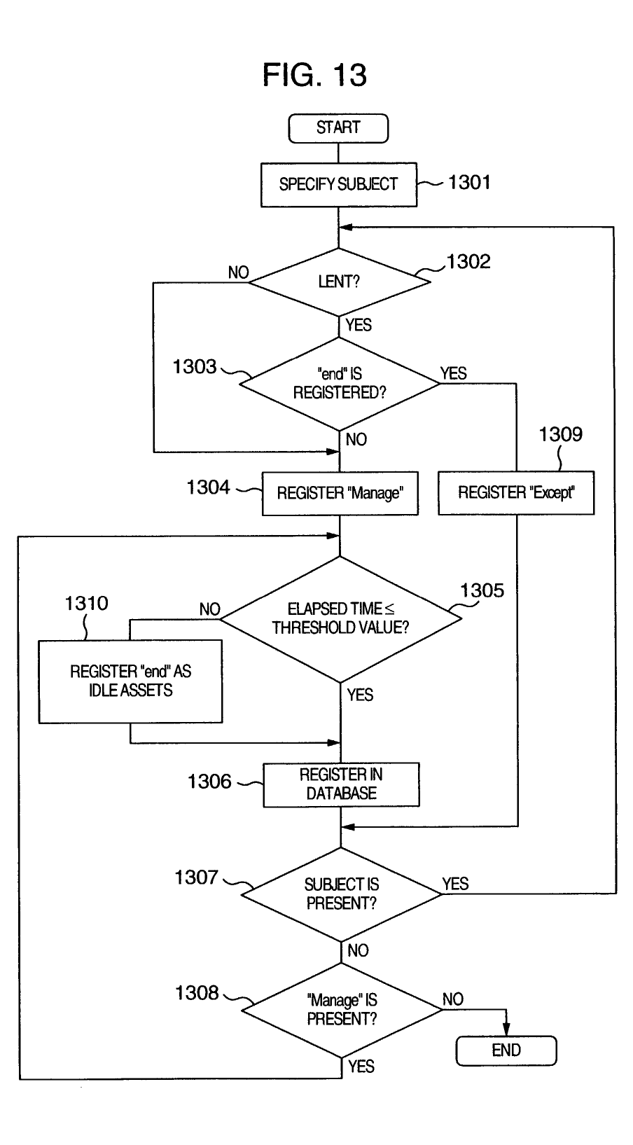

The use rate virtual manager 708 corresponds to such a virtual manager capable of judging as to whether or not an information processing equipment corresponds to idle assets. FIG. 13 shows process operations of the use rate virtual manager 708.

The use rate virtual manager 708 specifies such a reference number as a subject to be processed, and reads out a conducting mode of this reference number from the database 730 (step 1301). As to this reference number, any one of these indications “manage”, “except”, “end” is not registered in the column of the use rate virtual manager of the virtual manager management table 720. In this case, in such a case that the reference number has been registered as “lend” as to the conducting mode (“YES” in process step 1302), the use rate virtual manager 708 checks as to whether or not the reference number has been registered as “end” with reference to a column of a contract virtual manager of this reference number (step 1303). In such a case that the reference number has been registered as “end” (“YES” in process step 1303), this indicates such a condition that the use term of this information processing equipment has passed, and the management of the contract virtual manager 707 has been completed. As a consequence, since this information processing equipment is not utilized, this information processing equipment is derived from the subject of the use rate virtual manager 708. In other words, the use rate virtual manager 708 registers the indication “except” into a column of the use rate virtual manager corresponding to this reference number (step 1309). In a case that the reference number has not yet been registered as “end” (“NO” in process step 1303), the indication “manage” is registered so as to manage this reference number by the use rate virtual manager 708 (step 1304).

Next, the use rate virtual manager 708 compares a use rate of a memory and a use rate of a CPU, which are sent from an information processing equipment, with preset threshold values (step 1305). When the use rate of the memory and the use rate of the CPU are lower than the preset threshold values (“YES” in process step 1305), the use rate virtual manager 708 registers “idle assets” into the database 730 (step 1310), and also registers the use rates into the database 620 (step 1306). Next, the use rate virtual manager 708 investigates as to whether or not such a reference number to which any one of these indications “manage”, “except”, “end” has not yet been registered is present in a column of the use rate virtual manager of the virtual manager management table 720 in a similar manner to that of the above-described process step 1301 (step 1307). If there is the subject reference number (“YES” in process step 1307), then the use rate virtual manager 708 specifies this reference number as the managing subject, and then reads out a conducting mode of this reference number from the database 730 (step 1311). If there is no subject reference number, then the use rate virtual manager 708 checks as to whether or not there is such a reference number which has been registered as “manage” in a column of the use rate virtual manager in the virtual manager management table 720 (step 1308). When there is the reference number registered as “manage” (“YES” in process step 1308), the use rate virtual manager 708 waits for a preselected time period, and then, the process operation is returned to the previous step 1305.

It should also be noted that there are use rates of CPUs and use rates of memories, the use rate virtual manager 708 may calculate average values thereof and then may compare these averaged values with threshold values. Also, in a case that a utilization rate of an information processing equipment is calculated, this utilization rate may be obtained as follows. That is, total time after the power supply of the information processing equipment has been turned ON is sent from the information processing equipment to the use rate virtual manager, and this use rate virtual manager calculates T2/T1 so as to obtain the utilization rate from both the time elapse “T1” from the use starting date and the total time “T2” after the power supply is turned ON. While this calculated utilization rate is compared with the threshold value, when this utilization rate is smaller than, or equal to the threshold value, the use rate virtual manager 708 may register this information processing equipment as “idle assets”.

Also, when this utilization rate is smaller than, or equal to the threshold value, (“NO” in process step 1305), the use rate virtual manager 708 registers this information processing equipment as “idle assets” in the step 1310. Alternatively, the use rate virtual manager 708 may register “end” into the virtual manager management table 720 so as to lock the information processing equipment.

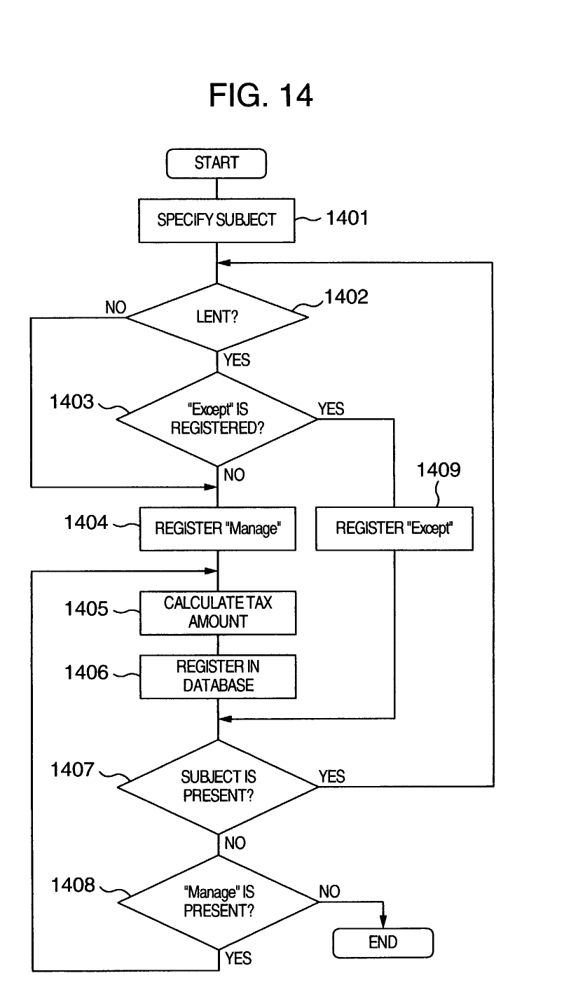

The depreciation virtual manager 709 implies such a virtual manager which calculates a tax rate (taxation rate) of depreciation assets. FIG. 14 indicates process operations of the depreciation virtual manager 709.

It should be understood that the process operations executed by the depreciation virtual manager 709 are substantially equal to those of the use rate virtual manager 708. A difference of the depreciation virtual manager 709 from the use rate virtual manager 708 is to calculate a tax amount (step 1405). A tax amount is calculated in such a manner that an evaluation amount is calculated, and then, the calculated evaluation amount is processed by using a preselected coefficient. For instance, a calculation of an evaluation amount is given as follows:

Evaluation amount=acquired price (1−reduction rate/2).

Evaluation amount=price in last year (1−reduction rate).

Also, a tax calculation is given as follows:

Tax amount=evaluation amount×tax rate.

The tax amount which has been calculated in this manner is registered into the database 730.

It should also be noted that the calculation formula for obtaining the tax amount may be freely set.

The charging virtual manager 710 corresponds to such a virtual manager capable of calculating a use fee of an information processing equipment from a use term. The process operations of the charging virtual manager 710 are substantially same as those of the depreciation virtual manager 709. That is, the process operation for calculating a tax amount is replaced by such a process operation for calculating a use fee.

For instance, in such a case that a monthly payment is amount to “a” Yen, a use fee may be calculated in the below-mentioned formula:

Use fee=“a”×elapse time/720.

Elapse time is equal to time measured from a use starting date.

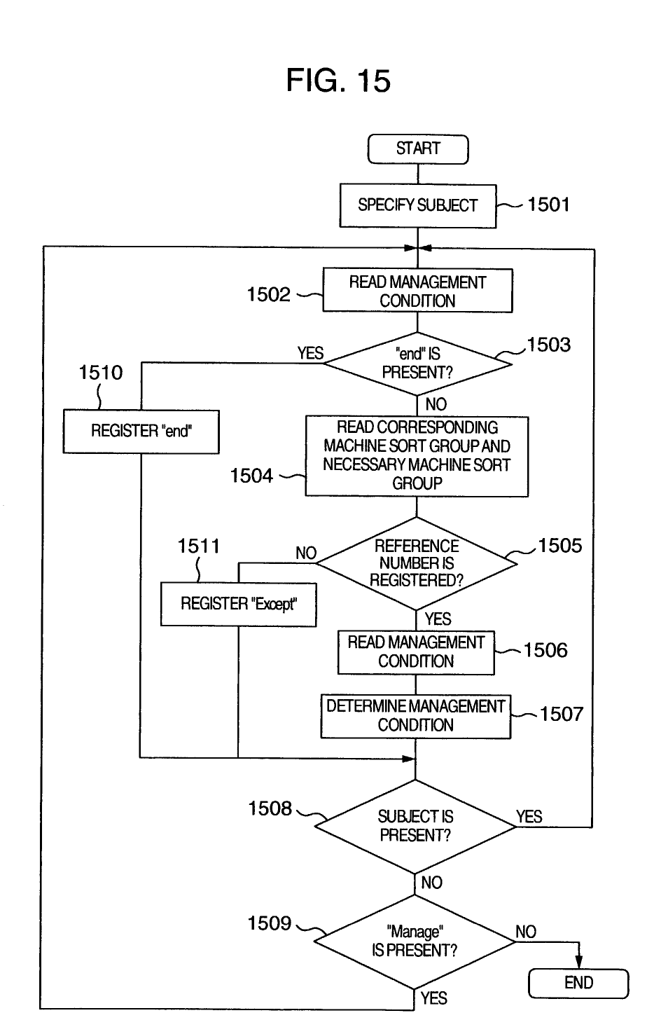

The group virtual manager 711 is such a manager which manages a grouped information processing equipment. FIG. 15 indicates a process operation of the group virtual manager 711. The group virtual manager 711 specifies as a processing subject such a reference number to which any one of “manage”, “except”, and “end” has not been registered from the virtual manager management table 720 (step 1501). Next, the group virtual manager 711 reads out a management condition of a contract virtual manager of the specified reference number from the virtual manager management table 720 (step 1502). In this case, in a case that the management condition corresponds to the condition “end” (“YES” in process step 1503), the group virtual manager 711 registers the indication “end” into a column of the group management virtual manager corresponding to the specified reference number (step 1510). In a case that the management condition of the contract virtual manager is a condition other than “end” (“NO” in process step 1503), the group virtual manager 711 reads both a corresponding machine sort group and a necessary machine sort group of the subjective reference number from the database 730 (step 1504). In such a case that the reference number has not been registered to either the corresponding machine sort group or the necessary machine sort group (“NO” in process step 1505), the group virtual manager 711 registers the indication “except” into a column of the group management virtual manager in the virtual manager management table 720 with respect to the reference number specified in the process step 1501 (step 1511). In such a case that the reference number has been registered to either the corresponding machine sort group or the necessary machine sort group (“YES” in process step 1505), the group virtual manager 711 reads from the virtual manager management table 720, such a management condition of a contract virtual manager which is made coincident with the reference number registered in either the corresponding machine sort group or the necessary machine sort group (step 1506). The group virtual manager 711 determines a management condition of the reference number specified in the process step 1501 based upon both the content of the reference number registered in either the corresponding machine sort group or the necessary machine sort group, and also the management condition of the contract virtual manager (step 1507). This determining method is carried out in accordance with the below-mentioned manner.

First, description will now be made of such a case that a reference number has been registered only to the necessary machine sort group 818. In this case, even if there is only one “end” as the management condition of the contract virtual manager with respect to the reference number registered in the necessary machine sort group 818, the group virtual manager 711 registers “end” to the management condition of the group virtual manager of the reference number specified in the process step 1501, and registers “manage” in a case other than the above-described case.

Next, description will now be made of such a case that a reference number has been registered only to the corresponding machine sort group 817. In this case, even if there is only one “manage” as the management condition of the contract virtual manager with respect to the reference number registered in the corresponding machine sort group 817, the group virtual manager 711 registers “manage” to the management condition of the group virtual manager of the reference number specified in the process step 1501. In a case that the management conditions of all of the contract virtual managers are “end”, the group virtual manager 711 registers “end” to the management condition of the group virtual manager of the reference number specified in the process step 1501.

In such a case that reference numbers have been registered to both the corresponding machine sort group 817 and the necessary machine sort group 818, the group virtual manager 711 determines management conditions in the corresponding machine sort group 817 and the necessary machine sort group 818, respectively. As a result, in the case that two results of “manage” and “end” are obtained, the group virtual manager 711 determines “manage” preferentially.

In this case, in such a case that the information processing equipment having the reference number registered in any one of the corresponding machine sort group 817 and the necessary machine sort group 818 is managed by the contract virtual manager, the information processing equipment is managed by the group virtual manager. As a consequence, in such a case that the information processing equipment has been registered as “manage”, it can be seen that there is the information processing equipment which has been registered as the group by referring to the virtual manager management table 720. Accordingly, since there is such an information processing equipment which requires this information processing equipment registered as the group, either the manager or the user can judge that the information processing equipment cannot be disposed.

After the management condition of the reference number specified in the process step 1501 has been determined, the group virtual manager 711 specifies a next processing subject (step 1508). In this step 1508, the group virtual manager 711 specifies as a processing subject such a reference number to which any one of “manage”, “except”, “end” has not been registered from the virtual manager management table 720 in a similar manner to that of the process step 1501. When the processing subject is present (“YES” in process step 1508), the process operation is returned to the previous process step 1502. In a case that the processing subject is not present in the process step 1508 (“NO” in process step 1508), the group virtual manager 711 checks as to whether or not there is another reference number which has been registered as “manage”. When there is such a reference number, the group virtual manager 711 specifies this reference number as the processing subject, and then the process operation is returned to the previous process step 1502. As explained above, the group virtual manager 711 registers into the virtual manager management table 710, such a fact as to whether or not the information processing equipment to be processed is managed as the group based upon the management conditions of other information processing equipments which are related as the group.

In this embodiment, “manage” and “end” are determined in accordance with the management condition of the contract virtual manager 707. However, in such a case that the contract virtual manager 707 corresponds to “end”, the contract term expires, so that the information processing equipment cannot be utilized. In such a case, the use term of the database 730 of the assets management server 110 may be utilized. Alternatively, if such information for indicating as to whether or not the information processing equipment is the managing subject is stored in the database 730, this information may be utilized. Also, if there is another virtual manager for indicating as to whether or not the information processing equipment is used, then this result may be utilized.

In this embodiment, five sorts of virtual managers have been described. Alternatively, other virtual managers may be utilized, depending upon a content of management.

As to these five virtual managers, the process operations are commenced when the previously explained initial setting operation is carried out.

Next, as shown in FIG. 2(c), description will now be made of process operations of the virtual manager control unit after the initial setting operation has been accomplished.

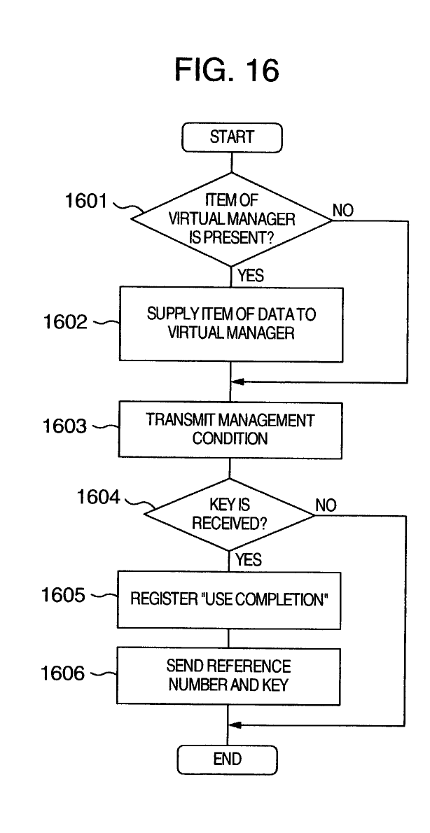

FIG. 16 indicates process operations of the virtual manager control unit 702 of the assets management server 110 whose the initial setting operation has been accomplished. An information processing equipment, the initial setting operation of which has been complete, sends a reference number to the assets management server 110. At this time, when the information processing equipment is so required that an item required by a virtual manager is sent in the initial setting operation, this information processing equipment sends data of this item in connection with the reference number. Then, the virtual manager control unit 702 confirms as to whether or not the item required by the virtual manager is transmitted (step 1601). When such an item is sent (“YES” in process step 1601), the virtual manager control unit 702 supplies the data of this item to the virtual manager (step 1602). Next, while referring to the virtual manager management table 720, the virtual manager control unit 702 transmits a management condition (either “manage” or “end”) of a virtual manager of this reference number to the information processing equipment (step 1603), and waits for a predetermined time period as to whether or not a response is issued from the information processing equipment. Upon receipt of the management condition “end”, the information processing equipment locks the own information processing equipment, and sends a key for releasing this locking condition to the assets management server 110 in connection with the reference number.

After the virtual manager control unit 702 waits for a predetermined time period, this virtual manager control unit 702 confirms as to whether or not the key is sent from the information processing equipment (step 1604). When the key is sent (“YES” in process step 1604), the virtual manager control unit 702 registers “end of use” into a column of a use condition of the information within the database 730 (step 1605). Also, the virtual manager control unit 702 reads out an address of the non-assets management server 100 which has borrowed the information processing equipment from the database 730, and then sends thereto both the reference number and the key (step 1606).

As indicated in FIG. 3, when the use condition notifying unit 705 receives the notification as to the management condition from the assets use management server 120, this use condition notifying unit 705 sends a use source, a use term, a reference number, a product name, and a use condition from the database 730 to the use management server 120. Also, when such a reference number of the information processing equipment which is not made coincident is received from the user management server 120, the use condition notifying unit 705 displays both the reference number and the product name on the terminal.

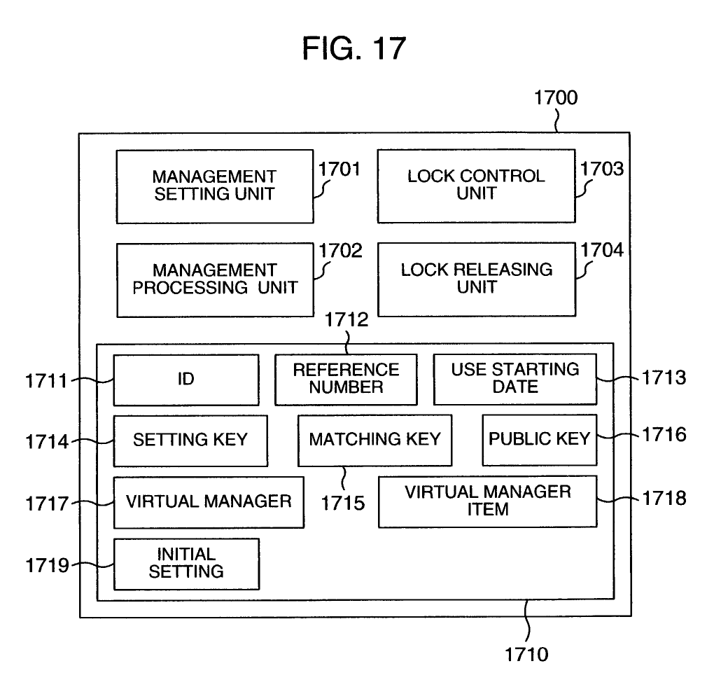

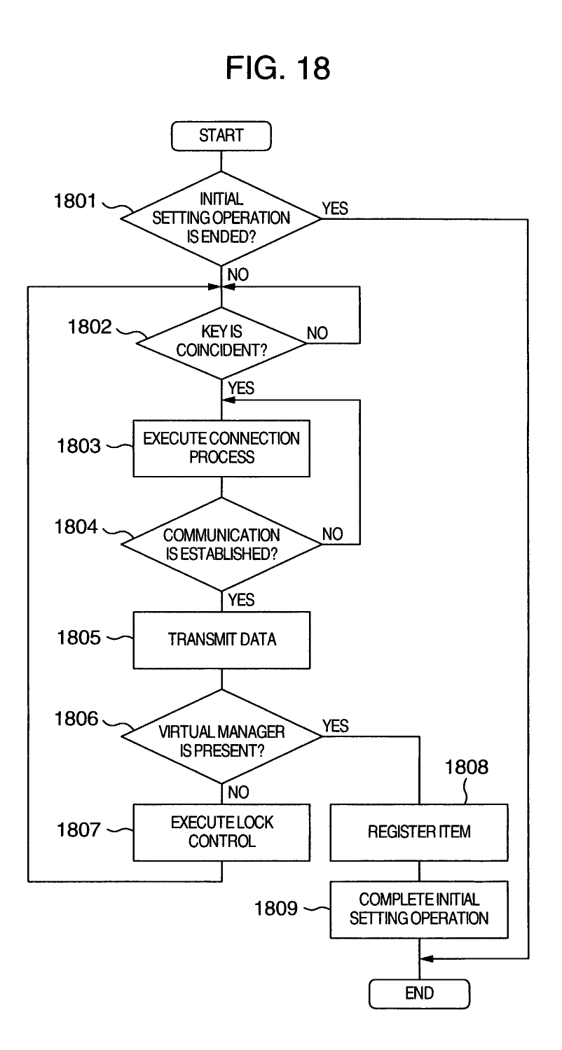

FIG. 17 schematically shows an arrangement of an assets agent 1700 installed in an information processing equipment. The assets agent 1700 contains a management setting unit 1701, a management processing unit 1702, a lock control unit 1703, and a lock releasing unit 1704. The management setting unit 1701 executes management between the own assets agent 1700 and the assets management server 110. The lock control unit 1703 causes an application program of an information processing equipment not to be executed. The lock releasing unit 1704 releases a locking condition. When a power supply of the information processing equipment is turned ON, after an operating system has been initiated, the management setting unit 1701 of the assets agent 1700 is initiated. The management setting unit 1701 is employed so as to execute an initial setting operation, and when the initial setting operation is ended, an application program of the information processing equipment may be used. For instance, after the initial setting operation has been accomplished, an icon of an application program is displayed. When the lock control unit 1703 of the assets agent 1700 is initiated, this lock control unit 1703 brings the initial setting operation into an uncompleted condition, so that the application program cannot be newly initiated. It should be noted that even when the information processing equipment is locked by the lock control unit 1703, the lock releasing unit 1704 may be initiated. Operation of the respective units will be explained later.

Also, the information processing equipment contains a storage area 1710 into which an ID 1711, a reference number 1712, a use starting date 1713, a setting key 1714, an identification key 1715, a public key 1716, and a virtual manager name 1717 may be registered.

When the power supply of the information processing equipment is turned ON, the management setting unit 1701 commences the process operation. First, the management setting unit 1701 confirms as to whether or not an initial setting operation has been ended (step 1801). In such a case that the initial setting operation has been ended (“YES” in process step 1801), the management setting unit 1701 accomplishes the process operation. When the initial setting operation is not yet ended (“NO” in process step 1801), the management setting unit 1701 reads the identification key 1715 stored in the storage area 1710 of the information processing equipment, and then confirms as to whether or not the read identification key 1715 is made coincident with the setting key 1714 (step 1802). In such a case that either the identification key 1714 is not made coincident with the setting key 1714, or the identification key is not stored (“NO” in process step 1802), the process operation is returned to the process operation 1802. A condition under which the information processing equipment is locked corresponds to such a condition that the setting key 1714 is deleted from the storage area 1710. When the setting key 1714 is deleted, the management setting unit 1701 repeatedly executes the process step 1802, so that this condition is brought into such a condition that the initial setting operation has not yet been ended, and the application program cannot be initiated.

On the other hand, in such a case that the identification key 1715 is made coincident with the setting key 1714 (“YES” in process step 1802), the management setting unit 1701 executes a connection process operation with respect to the assets management server 110 (step 1803). In a case that a communication cannot be established between a own assets agent 1700 and the assets management server 110, the management setting unit 1701 displays a setting view of a network. An operator designates an address of the assets management server 110 from this setting view. After the address setting operation has been carried out by the operator, the management setting unit 1701 again executes a connection process operation with respect to the assets management server 110 (step 1803). When a communication can be established between the own assets agent 1700 and the assets management server 110 (“YES” in process step 1804), the management setting unit 1701 sends the reference number 1712 registered in the storage area 1710 to the assets management server 110 (step 1805). It should be noted that if the virtual manager name 1717 has been registered at this time, then the management setting unit 1701 also sends this virtual manager name 1717 in connection with the reference number.

The management setting unit 1701 of the information processing equipment stores the item required to execute the process operation of the virtual manager into the storage area 1710 when this item is transmitted from the assets management server 110 (step 1808), and registers such a fact that the initial setting operation is completed (step 1809), and then, accomplishes the initial setting process operation.

On the other hand, the management setting unit 1701 which has received such a notification that there is no virtual manager from the assets management server 110 initiates the lock control unit 1703 (step 1807), and then the process operation is returned to the process step 1802.

The above-described process operations correspond to the initial setting operation required to manage the information processing equipment.

Next, description will now be made of process operation of the management processing unit 1702. This management processing unit 1702 is employed so as to execute the process operation shown in FIG. 2(c).

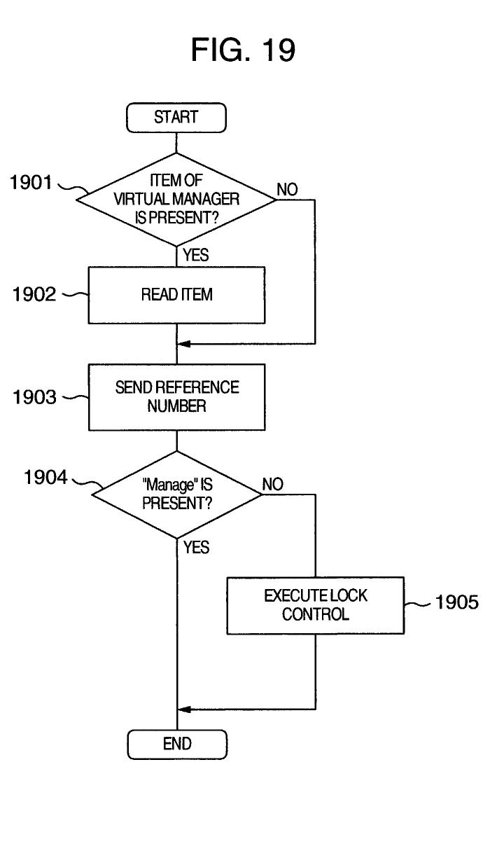

FIG. 19 shows process operation of the management processing unit 1702. If the management processing unit 1702 is requested by the assets management server 110 to send the items required for the virtual manager of the management server 110 (“YES” in process step 1901), then this management processing unit 1702 reads out the items required for the virtual manager and then acquires data which can satisfy the respective items (step 1902). For example, if these requested items are a use rate of a memory and a use rate of a CPU, then the management processing unit 1702 acquires a memory use rate and a CPU use rate, which are managed by an operating system. Then, the management processing unit 1702 sends the data of the items required for the virtual manager, which have been acquired in this manner, to the assets management server 110 in connection with the reference number (step 1903).

When the data sent from the assets management server 110 corresponds to “manage” (“YES” in process step 1904), the management processing unit 1702 ceases the process operation. On the other hand, when the data sent from the assets management server 110 corresponds to “end” the management processing unit 1702 initiates the lock control unit 1703 (step 1905).

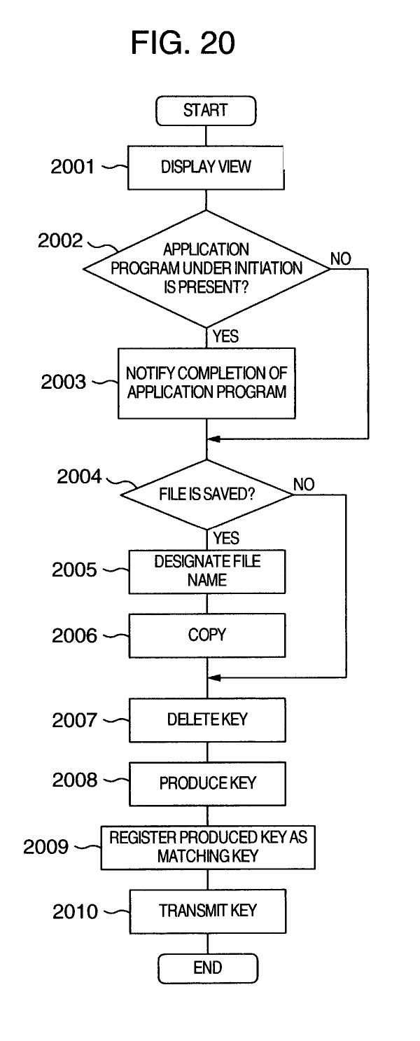

FIG. 20 shows process operations executed by the lock control unit 1703.

When the lock control unit 1704 is initiated, this lock control unit 1704 displays on the screen, such a notification that an information processing equipment cannot be utilized (step 2001). Next, the lock control unit 1704 confirms as to whether or not there is an application program being initiated (step 2002). In a case that there is an application program being initiated (“YES” in process step 2002), the lock control unit 1704 displays on the screen, such a notification that the process operation is ended (step 2003). Next, the lock control unit 1704 interrogates as to whether or not a file is saved to an external storage apparatus. When the file is saved (“YES” in process step 2004), the lock control unit 1704 displays both a name of a file source and an input screen of a copy destination (step 2005), and then executes to copy the file (step 2006). Next, the lock control unit 1704 deletes a setting key stored in a storage unit (step 2007), and newly produces a key (step 2008). This key may be produced by employing, for instance, a random number. The lock control unit 1704 registers the produced key as the identification key 417 (step 2009). Also, the lock control unit 1704 encrypts the produced key by the public key while the produced key is employed as the setting key 1714, and then sends the encrypted key to the assets management server 110 (step 2010). At this time, the setting key 1714 is not registered into the storage area 1710. As previously explained, the lock control unit 1703 encrypts such a key used to release the locking condition based upon the public key. As a consequence, only such a person who has a secret key used to execute decrypting operation may release the locking condition.

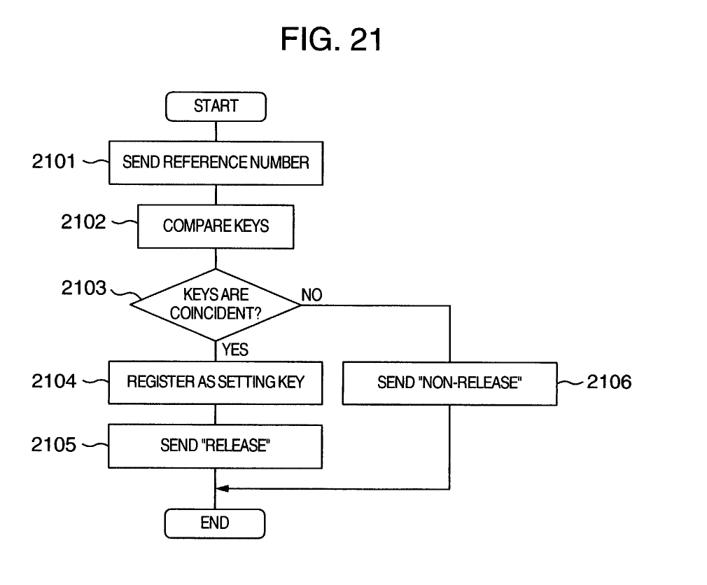

FIG. 21 shows process operation executed by the lock releasing unit 1704. This process operation is to execute the process operation shown in FIG. 2(d).

When the lock releasing unit 1704 receives a notification for executing a recovery from the non-assets management server 100, this lock releasing unit 1704 sends a reference number to the non-assets management server 100 (step 2101). The non-assets management server 100 decrypts such a key which has been previously sent, and then sends the decrypted key to an information processing equipment. The lock releasing unit 1704 compares the sent key with the identification key (step 2102). When the sent key is made with the identification key (“YES” in process step 2103), this lock releasing unit 1704 registers this sent key as the setting key (step 2104), and also notifies “release” to the non-assets management server 100 (step 2105). On the other hand, in a case that the sent key is not made coincident with the identification key (“NO” in process step 2103), the lock releasing unit 1704 notifies “not release” to the non-assets management server 100 (step 2106).

The non-assets management server 100, the assets management server 110, and the assets agent 1700 have been explained in the above description, which constitute the assets management system shown in FIG. 1.

Also, the assets agent 1700 of the information processing equipment explained in this embodiment has made the inquiry to the assets management server 100 in order to judge as to whether or not the own information processing equipment is to be managed. Alternatively, the virtual manager 706, the virtual manager control unit 702, and also, the virtual manager management table 720, which are explained in the assets management server 110, may be provided with the information processing equipment. In this case, the assets agent of the information processing equipment makes an inquiry with respect to the assets management server and each virtual manager control control unit of the information processing equipment. Then, in such a case that responses issued from the respective virtual manager control units are different from each other, if the information processing equipment is locked, then the information processing equipment may be managed in the correct manner even when the information processing equipment is connected to another assets management server different from the above-described assets management server for some reason.

Alternatively, all of the virtual managers owned by the assets management server need not be owned by the information processing equipment, but these virtual managers may be managed in a necessary manner.

Next, an assets management system according to another embodiment of the present invention will now be described.

In FIG. 1, the non-assets management server 100 and the assets management server 110 have been separately explained in the description. In this embodiment, description will be made of such an assets management server which may own the functions of the non-assets management server 100 and of the assets management server 110. In other words, even manufacturing parties who market information processing equipments and lending parties who lend information processing equipments may borrow information processing equipments, and also may purchase to use information processing equipments. In such a case, if the assets management system may be realized by a single server rather than two management servers such as the non-assets management server 100 and the assets management server 110, then a higher efficiency may be achieved.

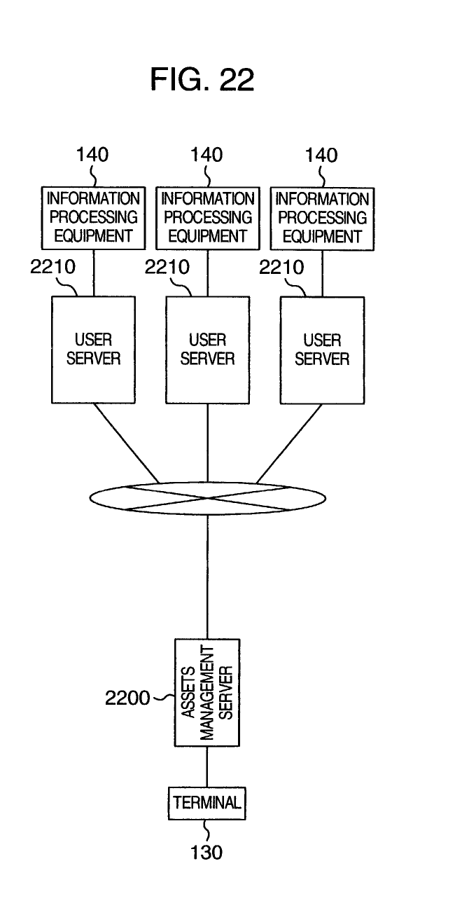

FIG. 22 schematically indicates an arrangement of a system which manages assets of a plurality of firms. This assets management system contains an assets management server 2200 which manages assets owned by the plural firms, and also a user server 2210 which is communicated with the assets management server 2200.

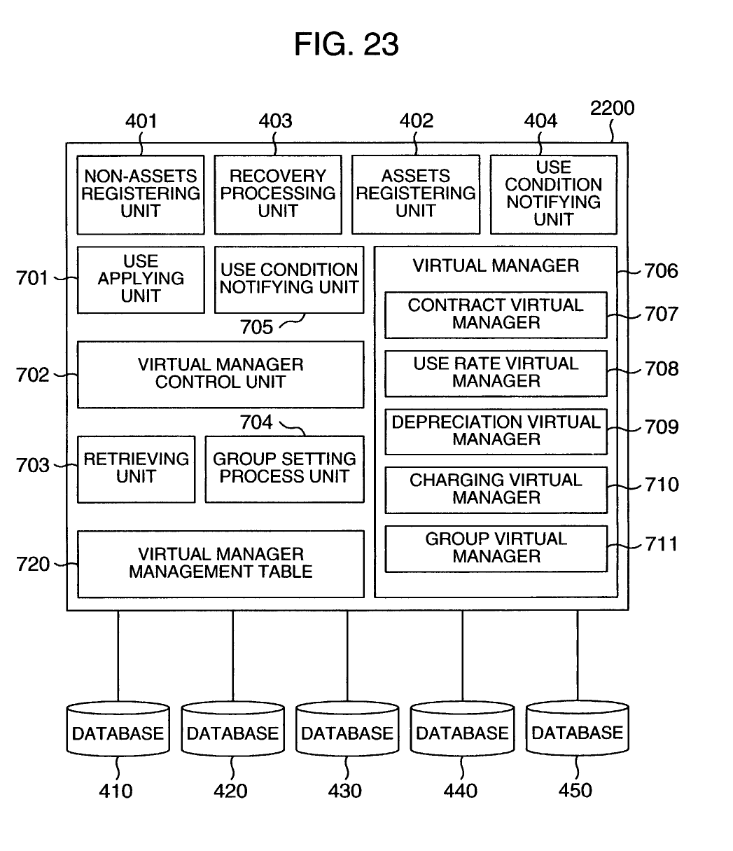

FIG. 23 schematically represents an arrangement of the assets management server 2200. It should be understood that the same reference numerals shown in the previously-explained respective functions/units are employed for indicating the same functions/units of the assets management server 2200. This assets management server 2200 may constitute an arbitration server which arbitrates between a party who lends an information processing equipment and a party who borrows an information processing equipment, and further arbitrates between a party who markets an information processing equipment and a party who purchases an information processing equipment. It should also be understood that the below-mentioned description is made, while a user of a server provided on the side of the parties who lend and market the information processing equipments is referred to as a non-assets registering person, whereas a user of a server provided on the side of the parties who borrow and purchase the information processing equipments is referred to as an assets registering person.

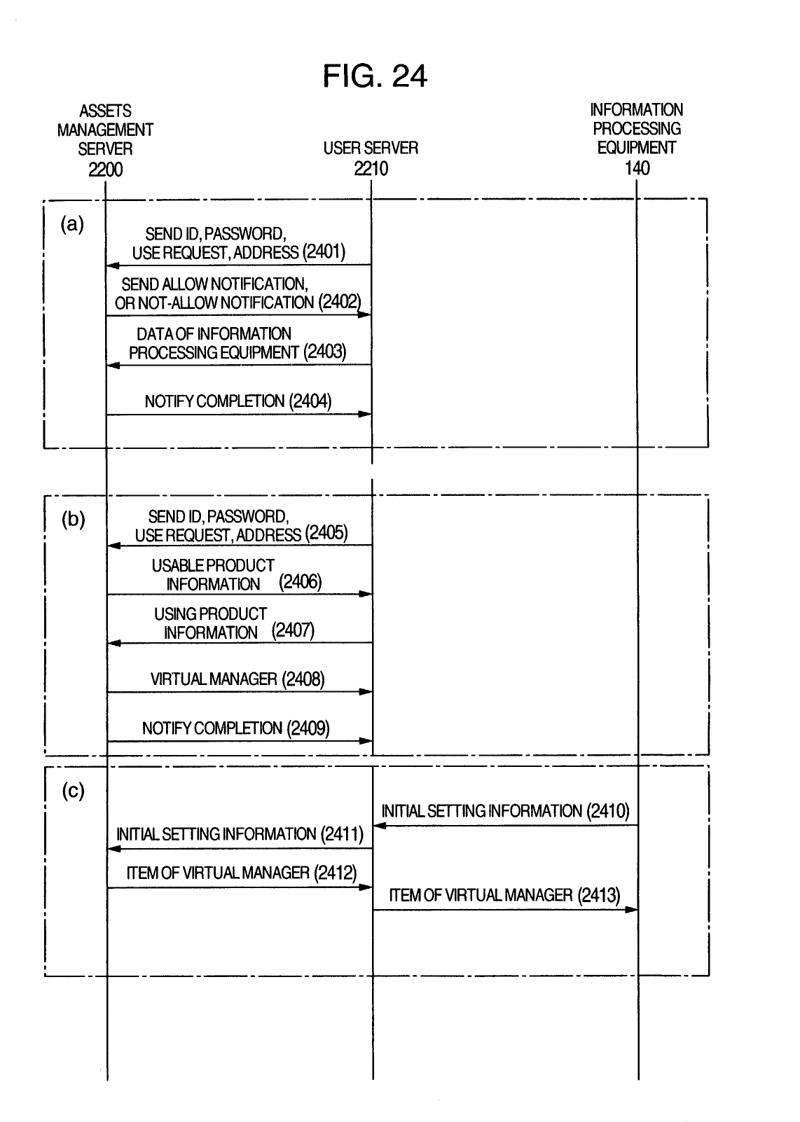

Next, overall operation of the assets management system of this embodiment shown in FIG. 24 will now be described.

FIG. 24(a) explains such an operation that a non-assets registering person registers a non-assets product. The non-assets product sends both an ID and a password, which indicate the non-assets registering person, and also sends a non-assets registering request for registering the non-assets product and an address of the user server 2210 from this user server 2210 to the assets management server 2200 (step 2401). In a case that the assets management server 2200 judges such a fact that the non-assets registering person owns authority to register the non-assets product based upon the transmitted ID and password, this assets management server 220 sends a registration-allowed notification to the user server 2210, whereas when the transmitted ID and password are not made coincident, this assets management server 2200 sends a registration-not-allowed notification to the user server 2210 (step 2402). The non-assets registering person which has received the registration-allowed notification transmits data about an information processing equipment to the assets management server 2200, which is registered from the user server 2210 (step 2403).

The data sent to the assets management server 2200 are: an ID 501 of the database 410; an ID 521 of the database 420; a use condition 502 thereof; a state 503 thereof; a model name 522 thereof; a product name 523 thereof; a technical specification 525 thereof; a price 528 thereof; a corresponding machine sort 526 thereof; and a necessary machine sort 527 thereof, while these databases 410 and 420 are contained in the assets management server 2200.

Also, since data of a virtual manager, a content of a process operation executed by the virtual manager, and a data item required for the virtual manager are sent to the assets management server 2200, these items are registered in the database 440 of the assets management server 220 of the non-assets registering person.

When the assets management server 1200 accomplishes to register both the data of the information processing equipment and the data of the virtual manager into the databases, this assets management server 220 sends a registration completion notification to the user server 2210 of the non-assets registering person, and then, the process operation is accomplished (step 2404).

FIG. 24(b) represents an application processing operation executed to use an information processing equipment managed by the assets management server 2200.

An assets registering person sends an ID, a password, a use request, and an address from the user server 2210 to the assets management server 2200 (step 2405). The assets management server 2200 which has received the use request selects a usable information processing equipment and a usable virtual manager. The assets management server 2200 transmits as “usable product information” to the user server 2210 of the assets registering person, a product name; a state; a manufacturing source; a technical specification; a corresponding machine sort; a necessary machine sort; a price; a name of a virtual manager, and the like as to an information processing equipment (step 2406). The assets registering person selects such an information processing equipment and a virtual manager, which are used, and then, transmits a reference number, a conducting mode, a use term, and a use destination as “using product information” from the user server 2210 to the assets management server 2200 (step 2407). The assets management server 2200 registers the received information into the database. It should also be noted that when a virtual manager is selected by the user server 2210, the assets management server 2200 reads out the relevant virtual manager from the database and then sends this read virtual manager to the assets management server 2200 (step 2408). When the above-described process operations are accomplished, the assets management server 2200 transmits “completion notification” to the user server 2210 of the assets registering person, while this “completion notification” indicates that the process operations are ended (step 2409). The user server 2210 receives “completion notification” and then accomplishes the process operations.

FIG. 24(c) shows initial setting operation executed so as to manage the information processing equipment 140 by the assets management server 110.

When the power supply of the information processing equipment 140 is turned ON, the information processing equipment 140 executes the initial setting operation.

The information processing equipment 140 sends such information as to a reference number, a use destination, a use starting date, a use term, and a virtual manager name as initial setting information supplied to the user server 2210 of the assets registering person (step 2410). The user server 2210 sends the initial setting information received from the information processing equipment 140 to the assets management server 2200 (step 2411). The assets management server 2200 confirms as to whether or not this relevant information equipment 140 has issued the request based upon the received reference number, and then initiates a virtual manager. Next, this assets management server 2200 sends an item required to execute a process operation of the initiated virtual manager to the user server 2210 of the assets registering person (step 2412). The user server 2210 of the assets registering person sends the received item required to execute the process operation of the virtual manager to the information processing equipment 140 (step 2413). The information processing equipment 140 stores the sent item required to execute the process operation of the virtual manager into a storage area, and accomplishes the initial setting process operation.

In assets management server 2200, the virtual manager is initiated so as to manage the information processing equipment 140.

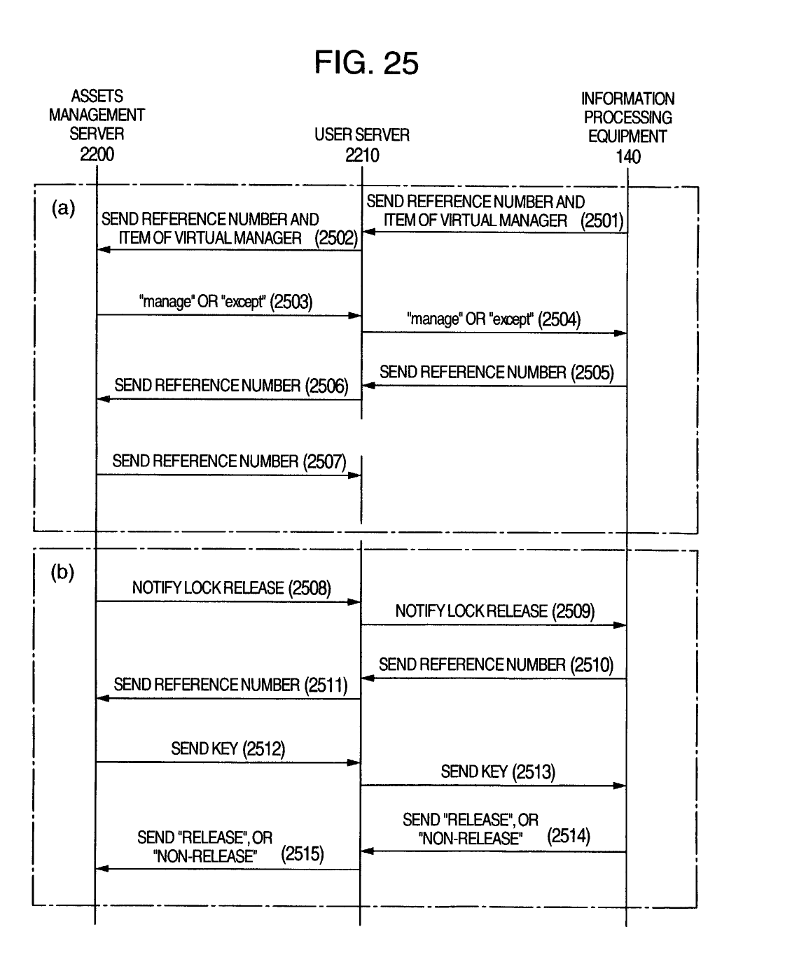

FIG. 25(a) shows operations between the assets management server 2200 in which the initial setting operation has been complete, and the user server 2210 and also the information processing equipment 140. The assets management server 2200 manages the information processing equipment 140 by way of the initiated virtual manager. The information processing equipment 140 makes an inquiry via the user server 2210 of the assets registering person to the assets management server 2200 in order to confirm as to whether or not the own information processing equipment 140 is operated as effective (valid) assets.

The information processing equipment 140 regularly sends a reference number and data of an item required to execute a process operation of a virtual manager to the user server 2210 of the assets registering person (step 2501). The user server 2210 of the assets registering person sends the received reference number and the received data of the item required to execute the process operation of the virtual manager to the assets management server 2200 (step 2502). Then, the assets management server 2200 confirms as to whether or not the virtual manager which manages this information processing equipment 140 executes a process operation based upon the sent reference number. In a case that the virtual manager executes the process operation, the assets management server 2200 sends “manage” to the user server 2210 of the assets registering person; in such a case that the virtual manager does not executes the process operation, the assets management server 2200 sends “end” to the user server 2210 of the assets registering person; and in such a case that the virtual manager executes a process operation out of interest, the assets management server 2200 sends “except” to the user server 2210 of the assets registering person (step 2503). The user server 2210 of the assets registering person transmits either the received “manage” or the received “end”, or the received “except” to the information processing equipment (step 2504). When the information processing equipment 140 receives “message”, this information processing equipment 140 judges that the own information processing equipment 140 is managed by the assets management server 2200, and after a predetermined time period has elapsed, the information processing equipment 140 again sends the reference number and the data of the item required to execute the process operation of the virtual manager to the user server 2210 of the assets registering person (step 2501). The user server 2210 of the assets registering person sends the received reference number and the received data of the item required to execute the process operation of the virtual manager to the assets management server 2200 (step 2502).

On the other hand, when “end” is received, the information processing equipment 140 judges that the own information processing equipment 140 is not managed by the assets management server 2200. The information processing equipment 140 which judges that the own information processing equipment 140 is not managed by the assets management server 2200 is locked in order that the user cannot use this information processing equipment 140, and further, produces a key used to release the locking condition. Then, the information processing equipment 140 sends both the reference number and the produced key to the user server 2210 of the assets registering person (step 2505). The user server 2210 of the assets registering person sends both the reference number and the produced key to the assets management server 2200 (step 2506). Thereafter, the assets management server 2200 which has received both the reference number and the key transmits both the reference number and the produced key to a user server 2210 of a new non-assets registering person (step 2507).

FIG. 25(b) indicates a process operation for releasing a locking condition in order that a returned information processing equipment can be again used. The assets management server 2200 sends a lock release notification to the user server 2210 of the non-assets registering person (step 2508). The user server 2210 sends the lock-release notification to the information processing equipment 140 (step 2509). The information processing equipment 140 which has received the lock-release notification transmits such a reference number capable of specifying the own information processing equipment 140 to the user server 2210 (step 2510). The user server 2210 sends this reference number to the assets management server 2200 (step 2511). The assets management server 2200 reads the key which has been encrypted and acquired in FIG. 25(a) from the transmitted reference number, and then decrypts this encrypted key based upon a secret key. The assets management server 2200 sends the decrypted key to the information processing equipment 140 (step 2513). Then, the information processing equipment 140 releases the locking condition by using the transmitted key. When the locking condition is released, the information processing equipment 140 notifies “release” to the user server 2210, whereas when the locking condition is not released, the information processing equipment 140 notifies “non-release” to the user server 2210 (step 2514). The user server 2514 sends either “release” or “non-release” to the assets management server 2200 (step 2515).

As previously explained the assets management server may be utilized as the arbitration server. It should also be noted that the data registered in the database, the virtual manager, and the virtual manager management table may be provided every assets registering person.

It should also be understood that the information processing equipments corresponding to the management subjects of this embodiment have been described as such an initial condition that these information processing equipments own the communication function, the storage function such as the memory, and the process function such as the CPU (central processing unit). In addition, software programs may be employed as the management subjects. In this case, while a reference number is registered with respect to each of these software programs, a computer into which these software programs have been installed may execute process operations with respect to an assets management server. In this alternative case, such data has been previously stored in this assets management server, and this case indicates that the items which have been registered as the assets correspond to the software programs. The information processing equipment may delete a software program, or may send a locking instruction to an information processing equipment in order that the software program cannot be utilized when the management by the contract virtual manager is ended.

Also, floppy disks, magnetic disks, and microfilms may be employed as management subjects. In this alternative case, bar codes and the like, which indicate identifiers, are attached to the floppy disks, and the like, such an apparatus capable of reading these bar codes may execute a process operation with respect to an assets management server.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An assets management method for managing an information processing apparatus in accordance with a manager program owned by a management apparatus, said manager program comprising the steps of:
judging as to whether or not an information processing apparatus is operated within a use term based upon information of said use term of said information processing apparatus;
in a case that said information processing apparatus is operated within said use term, registering a fact that said information processing apparatus corresponds to assets into a storage unit of said management apparatus, and thereafter, further judging as to whether or not said information processing apparatus is operated within said use term; and
in a case that said information processing apparatus is not operated within said use term, accomplishing process operation of said manager program is accomplished.

2. An assets management method for managing an information processing apparatus by a manager owned by a management apparatus, comprising the steps of:
based upon information of a use term of an information processing apparatus, executing, by said manager, process operation indicative of such a fact that said information processing apparatus corresponds to assets until said information processing apparatus is operated out of said use term; and
responsive to a notification for notifying that said manager executes the process operation from said management apparatus, judging, by said information processing apparatus, that own information processing apparatus corresponds to said assets.

3. An assets management method for managing an information processing apparatus by a manager owned by a management apparatus, comprising the steps of:
based upon information of a use term of an information processing apparatus, accomplishing, by said manager, process operation indicative of a fact that said information processing apparatus corresponds to assets when said information processing apparatus is operated out of said use term; and
responsive to a notification for notifying that said manager accomplishes the process operation from said management apparatus, judging, by said information processing apparatus, that own information processing apparatus does not correspond to said assets.

4. An assets management method as claimed in claim 3, wherein:
when said information processing apparatus receives said notification that said manager accomplishes said process operation, an application program owned by said information processing apparatus cannot be executed.

5. An assets management method for managing an information processing apparatus by a manager owned by a management apparatus, comprising the steps of:
based upon information of a use term of an information processing apparatus, accomplishing, by said manager, process operation indicative of a fact that said information processing apparatus corresponds to assets when said information processing apparatus is operated out of said use term; and
responsive to a notification that said manger accomplishes said process operation from said management apparatus, locking, by said information processing apparatus, own information processing apparatus in a manner that an application program owned by said information processing apparatus cannot be executed, and sending information used to release said locking condition to said management apparatus.

6. An assets management method in which an information processing apparatus is managed by an agent owned by the information processing apparatus, comprising the steps executed by said agent of:
inquiring a management apparatus as to whether or not a subject for managing said information processing apparatus is present; and
when judging that the management subject is not present based upon a response issued from the management apparatus, accomplishing an application program under execution, locking said information processing apparatus in a manner that an application program owned by said information processing apparatus cannot be executed, and producing information for releasing said locking condition.

7. An assets management method for managing an information processing apparatus by a plurality of management apparatus, comprising the steps of:
notifying, by a first management apparatus for managing the information processing equipment, a fact that the information processing apparatus is out of management to said information processing apparatus;
receiving, by the information processing apparatus, a notification that own information processing apparatus is out of management, locking own information processing apparatus in a manner that an application program cannot be executed, and sending information for releasing a locking condition to a second management apparatus; and
releasing, by said second management apparatus, the locking condition of said information processing apparatus based upon information for releasing the locking condition.

8. An assets management method as claimed in claim 7, wherein:
said first management apparatus includes a manager for managing the information processing apparatus; and
in a case that said manager judges that a use term of said information processing apparatus has passed, said first management apparatus notifies that said information processing apparatus is out of management.

9. An assets management method in which an information processing apparatus is managed by an agent owned by the information processing apparatus, comprising the steps executed by said agent of:
inquiring a first management apparatus as to whether or not a management subject for managing said information processing apparatus is present; and
when judging that the management subject is not present based upon a response issued from the first management apparatus, accomplishing an application program under execution, locking said information processing apparatus in a manner that an application program owned by said information processing apparatus cannot be executed, and sending information for releasing said locking condition to a second management apparatus.

10. An assets management apparatus for managing an information processing apparatus, wherein:
said assets management apparatus is comprised of a manager; and said manager judges as to whether or not an information processing apparatus is operated within a use term based upon information of said use term of said information processing apparatus; in a case that said manager judges that said information processing apparatus is operated within said use term, said manager registers a fact that said information processing apparatus corresponds to assets of said assets management apparatus into a storage unit of said management apparatus, and thereafter, further judges as to whether or not said information processing apparatus is operated within said use term; and in a case that said manger judges that said information processing apparatus is not operated within said use term, process operation of said manager is accomplished.

11. An assets management system comprising an information processing apparatus and an assets management apparatus for managing the information processing apparatus, wherein:
said assets management apparatus is comprised of a manager which executes a process operation indicative of a fact that said information processing apparatus corresponds to assets until said information processing apparatus is operated out of said use term based upon information of a use term of said information processing apparatus; and
said information processing apparatus is comprised of an assets judging unit for judging that own information processing apparatus corresponds to said assets by receiving a notification for notifying that said manager executes the process operation from said assets management apparatus.

12. An assets management system comprising an information processing apparatus and an assets management apparatus for managing the information processing apparatus, wherein:
said assets management apparatus is comprised of a manager which accomplishes a process operation indicative of a fact that said information processing apparatus corresponds to assets when said information processing apparatus is operated out of a use term based upon information of said use term of said information processing apparatus; and
said information processing apparatus is comprised of an assets judging unit for judging that own information processing apparatus does not correspond to said assets by receiving a notification that said manager accomplishes said process operation from said assets management apparatus, said information processing apparatus locks own information processing apparatus in a manner that an application program owned by said information processing apparatus cannot be executed.

13. An assets management system as claimed in claim 12, wherein:
said information processing apparatus is comprised of a lock control unit operated in a manner that when said information processing apparatus receives said notification that said manager accomplishes said process operation, an application program owned by said information processing apparatus cannot be executed.

14. An assets management system comprising an information processing apparatus and an assets management apparatus for managing the information processing apparatus, wherein:
said assets management apparatus is comprised of a manager which indicates a fact that said information processing apparatus corresponds to assets until said information processing apparatus is operated out of a use term based upon information of the use term of said information processing apparatus; and
said information processing apparatus is comprised of a lock control unit operated in a manner that when said information processing apparatus receives a notification that said manager accomplishes said process operation from said assets management apparatus, said lock control unit locks that an application program owned by said information processing apparatus cannot be executed, and also sends information used to release said locking condition to said assets management apparatus.

15. An information processing apparatus comprising an agent, wherein:
said agent inquiries a management apparatus as to whether or not a subject for managing said information processing apparatus is present; and
when said agent judges that the management subject is not present based upon a response issued from the management apparatus, said agent accomplishes an application program under execution, locks said information processing apparatus in a manner that an application program owned by said information processing apparatus cannot be executed, and produces information for releasing said locking condition.

16. An assets management system for managing an information processing equipment by a plurality of management apparatus, wherein:
a first management apparatus for managing the information processing equipment notifies a fact that the information processing apparatus is out of management to said information processing apparatus;
the information processing apparatus which has received a notification that own information processing apparatus is out of management locks the own information processing apparatus in a manner that an application program cannot be executed, and sends information for releasing a locking condition to a second management apparatus; and
said second management apparatus releases the locking condition of said information processing apparatus based upon information for releasing the locking condition.

17. An assets management system as claimed in claim 16, wherein:
said first management apparatus includes a manager for managing the information processing apparatus; and
in a case that said manager judges that a use term of said information processing apparatus has passed, said first management apparatus notifies that said information processing apparatus is out of management.

18. An information processing apparatus comprising an agent, wherein:
said agent inquiries a first management apparatus as to whether or not a management subject for managing said information processing apparatus is present; and when said agent judges that the management subject is not present based upon a response issued from the first management apparatus, said agent accomplishes an application program under execution, locks said information processing apparatus in a manner that an application program owned by said information processing apparatus cannot be executed, produces information for releasing said locking condition, and sends information for releasing said locking condition to a second management apparatus.

19. An assets management method as claimed in claim 7, wherein:
said information for releasing said locking condition is encrypted in a manner that said encrypted information cannot be decrypted by said first management apparatus, and thereafter, said encrypted information is sent from said information processing apparatus via said first management apparatus to said second management apparatus.

20. An assets management method as claimed in claim 9, wherein:
said information for releasing said locking condition is encrypted in a manner that said encrypted information cannot be decrypted by said first management apparatus, and thereafter, said encrypted information is sent from said agent via said first management apparatus to said second management apparatus.

21. An assets management system as claimed in claim 16, wherein:
said information for releasing said locking condition is encrypted in a manner that said encrypted information cannot be decrypted by said first management apparatus, and thereafter, said encrypted information is sent from said information processing apparatus via said first management apparatus to said second management apparatus.

22. An information processing apparatus as claimed in claim 18, wherein:
said information for releasing said locking condition is encrypted in a manner that said encrypted information cannot be decrypted by said first management apparatus, and thereafter, said encrypted information is sent from said agent via said first management apparatus to said second management apparatus.
